(19) United States
(12) Patent Application Publication
(10) Pub. No.: US 2016/0012459 A1
(43) Pub. Date: Jan. 14, 2016

(54) METHODS FOR MANAGING PRICES AND DESCRIPTIONS OF PRODUCTS ON A SHOPPING WEBSITE

(71) Applicant: Helmut K. Heindel, Webster, NY (US)

(72) Inventor: Helmut K. Heindel, Webster, NY (US)

(21) Appl. No.: 14/755,450

(22) Filed: Jun. 30, 2015

Related U.S. Application Data
(60) Provisional application No. 62/022,248, filed on Jul. 9, 2014.

(51) Int. Cl. G06Q 30/02

(52) U.S. Cl. CPC G06Q 30/0206

(57) ABSTRACT

A method for managing prices and descriptions of products on a shopping website comprising the steps of identifying a complex product with a selectable option which may be selected to form a product configuration; identifying the price of the complex product; identifying an attribute for the complex product; identifying an attribute for each selectable option of the complex product; identifying a price for each selectable option of the complex product; and generating a product description data set comprising a price and an attribute for each product configuration of the complex product. The price of each product configuration may be based on the price of the complex product and the price of each selected option forming the product configuration, and the attributes of each product configuration may be based on the attributes of the complex product and on the attributes of each selected option forming the product configuration.

### CROSS REFERENCE TO RELATED APPLICATIONS

This application claims priority to and the benefit of the filing date of U.S. Provisional Application No. 62/022,248, filed on Jul. 9, 2014, entitled “METHOD FOR MANAGING PRICES AND DESCRIPTIONS OF PRODUCTS ON A SHOPPING WEBSITE”, which is hereby incorporated by reference in its entirety.

### FIELD OF THE INVENTION

This patent specification relates to the field of methods configured to manage properties of products. More specifically, this patent specification relates to computer implemented methods for managing listing prices and related properties of ecommerce products on a shopping website.

### BACKGROUND

During the past decade, the growth of ecommerce sites has been such that even small mom and pop stores can now afford to sell goods online. Many are in fact compelled to do so to survive.

There is a wide variety of shopping cart software available at reasonable cost, free in some cases, so it's quite easy to set up an empty online store with the aid of templates. A much more challenging and labor-intensive task is filling the virtual online shelves with products.

At present, online sellers have two options, both mutually exclusive: They can enter product prices and descriptions directly into shopping cart software via keyboard, one product at a time, or enter them into so-called import files and upload all their online products into commercial shopping cart software in bulk.

The first option is viable only if the seller's goods are limited to a small number of simple products with few or no options. Selecting this option pre-empts the second option because a general file import will overwrite any prior changes made by direct entry.

The second option is suitable for large quantities of both simple and complex products and tends to be more efficient. But it, too, has drawbacks. Import files are generally CSV, XML, or Excel text files that often contain tens of thousands of lines of text. Every line must still be entered manually, via keyboard, in the precise format prescribed by the shopping cart vendor. A single missing comma will unceremoniously terminate the import.

The second option brings with it a further disadvantage in that vendors of shopping cart software typically develop their own data structures and techniques for assembling and importing listing prices and related properties. This makes transferring a seller's hundreds, and often thousands, of products into alternate shopping cart software a herculean task. A reasonable observer might conclude that this lack of conformity among the import structures adopted by competing vendors is not accidental.

Both options suffer from excessive dependency on keyboard input. Complex products in particular involve an inordinate amount of arithmetic done on a calculator. For example, a simple T-Shirt offered in four sizes and five colors results in twenty separate configurations. A letterhead offered in ten quantities on four different types of paper, folded and unfolded, results in no less than eighty items that all need to be individually priced and entered. This reliance on manual, off-the-computer management makes it difficult to integrate either option with automated pricing software. Yet few activities in ecommerce could be helped more by having a computer do the arithmetic.

What is needed is an easy to use, automated method that can work with prior art pricing software to calculate the selling prices of online products. What is needed additionally is an easy to use, automated method that can convert the data structure of products stored in the seller's present shopping cart software into data structures used by competing vendors.

### BRIEF SUMMARY OF THE INVENTION

Methods for managing prices and descriptions of products on a shopping website are provided. In some embodiments, a database may be maintained apart from the shopping cart vendor's software that safeguards the seller's product data, while at the same time storing all necessary data objects to generate specific import files for a plurality of shopping cart vendors. Should the shopping cart software be incapable of file importing, the method produces a manual worksheet of products, prices, and rules that simplify manual data entry. In addition, the method circumvents the risk of overwrites, enabling the seller to enter corrections and price adjustments directly into the shopping cart software. In the event the seller's present shopping cart software is withdrawn from the market or more desirable software becomes available, it enables the seller to simply and conveniently transfer online products in bulk into shopping cart software from an alternate vendor.

In further embodiments, a method for managing prices and descriptions of goods sold on a shopping website and entering the managed information into commercially available shopping cart software, is provided in which: specifications and other information, including cost and price information, are received for a product in its standard configuration; details of product configurations are received for products with options; listing prices are calculated for all configurations in which the product can be ordered; values of all mandatory data fields required for importing the product into the seller's preferred shopping cart software are received; values of all mandatory data fields required for importing the product into alternate shopping cart software are received; a web products database comprising an aggregate of prices and information received is maintained in the cloud or on the seller's computer, independent of the database contained in the commercial shopping cart software; vendor-specific data sets are assembled from data retrieved from the web products database; a database comprising all data sets is maintained in the cloud or on the seller's computer, independent of a similar database contained in the commercial shopping cart software; an import file meeting the structural requirements, and containing all mandatory data fields for importing products into the seller's preferred shopping cart software, is constructed.

In further embodiments, the method may include the step of retrieving prices for products with or without options from an integrated pricing program.

In further embodiments, the method may include the step of retrieving prices for products without options from a suitable pricing database.

In further embodiments, the method may include the step of producing a manual worksheet to facilitate direct entry of a single product into the seller's preferred shopping cart software.

In further embodiments, the method may include the step of constructing an import file meeting the structural requirements, and containing all mandatory data fields for importing products into alternate shopping cart software.

In further embodiments, the method may include the step of retrieving historical sales information on which to base the selection of a specific product configuration as the default display configuration.

In further embodiments, the method may include the step of retrieving historical sales and current inventory data to determine whether to reduce the price of an overstocked item.

In still further embodiments, a computer implemented method for generating a product description data set for use on a shopping website which may be used to manage prices and descriptions of products on the shopping website is provided. The method may comprise the steps of identifying a complex product with one or more selectable options which may be selected to form a product configuration for the complex product; identifying the price of the complex product; identifying one or more attributes for the complex product; identifying one or more attributes for each selectable option of the complex product; identifying a price for each selectable option of the complex product; and generating a product description data set comprising a price and one or more attributes for each product configuration of the complex product, wherein the price of each product configuration of the complex product is based on the price of the complex product and the price of each selected option forming the product configuration for the complex product, and wherein the attributes of each product configuration of the complex product are based on the attributes of the complex product and on the attributes of each selected option forming the product configuration of the complex product.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a system according to various embodiments described herein.

FIG. 2 illustrates an example of a block diagram of a server which may be used in the system or standalone according to various embodiments described herein.

FIG. 3 shows an example of a block diagram of a client device according to various embodiments described herein.

FIG. 4 depicts a block diagram of an example of a product management system according to various embodiments described herein.

FIG. 5 illustrates a prior art database in which the data is organized according to a prior art data structure.

FIG. 6 shows a block diagram depicting an example database in which the data is organized according to various embodiments described herein.

FIG. 7 depicts an example of the master records table of database of FIG. 6 storing illustrative data according to various embodiments described herein.

FIG. 8 illustrates an example of the configuration records table of database of FIG. 6 storing illustrative data according to various embodiments described herein.

FIG. 9 shows an example of an Excel file storing an illustrative data set that imports T-Shirt data into “WooCommerce” shopping cart software according to various embodiments described herein.

FIG. 10 depicts an example of an Excel file storing an illustrative data set that imports T-Shirt data into “BigCommerce” shopping cart software according to various embodiments described herein.

FIG. 11 illustrates an Excel file of an example of a master records table of database of FIG. 7 storing illustrative data according to various embodiments described herein.

FIG. 12 shows an Excel file an example of a configuration records table of database of FIG. 8 storing illustrative data according to various embodiments described herein.

FIG. 13 depicts a process for entering a new product into a seller's shopping cart software according to various embodiments described herein.

FIG. 14 illustrates a process for updating an existing product in a seller's shopping cart software according to various embodiments described herein.

FIG. 15 shows an example of a manual worksheet for pricing the poster on the “BigCommerce” shopping web page depicted in FIG. 18. according to various embodiments described herein.

FIG. 16 depicts an example of a screen captured from “BigCommerce” shopping cart software illustrating rules that must be entered via keyboard to manage the pricing of the poster depicted in FIG. 18 according to various embodiments described herein.

FIG. 17 illustrates an example of an entry screen captured from “BigCommerce” shopping cart software illustrating rules that must be entered via keyboard to manage the pricing of the poster depicted in FIG. 18 according to various embodiments described herein.

FIG. 18 shows a screen capture illustrating an example of the web page resulting from the rules entered in FIGS. 16 and 17 according to various embodiments described herein.

FIG. 19 depicts a process for managing the display of the most desired configuration of a complex product on a seller's shopping website according to various embodiments described herein.

FIG. 20 illustrates a process for managing the listing price of an overstocked configuration of a complex product on the seller's shopping website according to various embodiments described herein.

FIG. 21 shows a block diagram of an example of a computer system for a print shop environment according to various embodiments described herein.

FIG. 22 depicts a screen capture of an exemplary entry screen designed to formulate a plurality of letterhead configurations for storage in the web products database of FIG. 21 according to various embodiments described herein.

FIG. 23 illustrates an Excel file storing an exemplary data set for importing the letterhead configurations formulated in FIG. 22 into “WooCommerce” shopping cart software according to various embodiments described herein.

FIG. 24 shows an Excel file storing an exemplary data set for importing the letterhead configurations formulated in FIG. 22 into “BigCommerce” shopping cart software according to various embodiments described herein.

FIG. 25 depicts a screen capture illustrating an example web page resulting from the data set depicted in FIG. 23 according to various embodiments described herein.

FIG. 26 illustrates an example of a process for entering a new product into shopping cart software designed for a print shop according to various embodiments described herein.

FIG. 27 shows a screen capture of an exemplary pick list for selecting the “print product” of FIG. 26 according to various embodiments described herein.

FIG. 28 depicts a screen capture of an exemplary entry screen for selecting the “paper items” of FIG. 26 according to various embodiments described herein.

FIG. 29 illustrates a screen capture of an exemplary entry screen for selecting “quantities” and “other options” in FIG. 26 according to various embodiments described herein.

FIG. 30 shows a screen capture from an exemplary functionality with shopping cart software from a plurality of vendors according to various embodiments described herein.

FIG. 31 depicts an example of a manual worksheet for managing the prices of the letterhead on the “BigCommerce” shopping web page depicted in FIG. 25 according to various embodiments described herein.

FIG. 32 shows a flow chart that illustrates an example of a computer implemented method for managing prices and descriptions of products on a shopping website according to various embodiments described herein.

### DETAILED DESCRIPTION OF THE INVENTION

### Definitions

The following terms, as used herein, shall have the meanings indicated below.

Algorithm—The term “algorithm” refers to computer code with step-by-step instructions for program execution.

API—The term “API” (Application Programming Interface) refers to a library of specifications that allows software components to interact with each other. When used in the context of web development, an API is typically defined as a set of request messages, along with a definition of the structure of response messages.

Associated Configuration—The term “associated configuration” refers to a configuration record controlled by, and exclusively belonging to, a master record in a database. Also known as “related record” in relational database terminology.

Attribute—The term “attribute” refers to descriptor data of a product and/or an option of a configurable product that may allow customers to more accurately define the product and/or one or more options of a configurable product they're looking for.

Attribute Set—The term “attribute set” refers to an array of descriptor data for a complex product. For example, small-medium-large would be an attribute set for T-Shirts.

Base Product—The term “base product” refers to the root configuration (without options) of a configurable product, and to the single configuration of a simple product.

Cloud—The term “cloud” refers to distributed computing over a network and means the ability to run a program or application on many connected computers at the same time.

As used herein, the term “complex product” refers to a product or service with one or more selectable options which may be chosen or added onto the complex product to form a configuration of the complex product. Configurable products, products with options or variations, and grouped products are all types of complex products. If a product is not complex, in that it does not have one or more selectable options which may be chosen or added onto it, then the product may be classified as a simple product.

As used herein, the term “computer” refers to a machine, apparatus, or device that is capable of accepting and performing logic operations from software code. The term “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

Configurable Product—The term “configurable product” refers to a product that has one or more options. A customer may build their own configuration of a product by selecting from an assortment of optional components or optional selections. For example, a configurable product computer that can be custom assembled using a choice of different optional processors and different optional hard drives. In another example, a configurable product t-shirt may have selectable options such as selectable colors and selectable sizes. A configurable product is a type of complex product.

CSV File—The term “CSV file” (character-separated-values file) refers to a text file in which tabular data are delineated by a comma or other character. For example, “Jane Doe, 123 Main Street, Anytown”, or “smalllmediumllarge”.

Customer—The term “customer” refers to a buyer or potential buyer of a good or service offered on a web store service.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e. a “wireless network”) which may include wifi and cellular networks.

Data Set—The term “data set” refers to a collection of prices, options, rules, and other properties for one or more products, including the prices and properties of all the product configurations. Data sets are vendor-specific and are generally provided as CSV or Excel files. Data set files enable shopping cart software to dynamically define web products and generate product-related web pages on a seller's shopping web site.

As used herein, the term “database” shall generally mean a digital collection of data or information such as one or more data sets. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e. information and data from a database may be recorded into a medium on a data store).

Default Configuration—The term “default configuration” refers to the configuration of a configurable product such as may be initially displayed on the seller's shopping web site. In general, this may represent the most popular configuration or selected options of a configurable product.

Dynamically—The term “dynamically” refers to a change or activity performed in real time while a computer program is running.

Ecommerce—The term “ecommerce” refers to a type of industry where the buying and selling of products or services is conducted over electronic systems such as the Internet and other computer networks, such as through a web store service.

The term “electronic device” as used herein is a type of electronic device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include; personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include; cell phones, smart phones, tablet computers, laptop computers, wearable computers such as watches, Google Glasses, etc. and the like.

The term “mobile device” or sometime “electronic device” or just “device” as used herein is a type of computer generally operated by a person. In some embodiments, a mobile device is a smart phone or computer, configured to receive and transmit data to a server which may be operated locally or in the cloud. Non-limiting examples of mobile devices include; personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of electronic devices which are portable and easily carried by a person from one location to another may sometimes be referred to as a “mobile device” or “portable device”. Some non-limiting examples of mobile devices include; cell phones, smart phones, tablet computers, laptop computers, wearable computers such as watches, Google Glasses, etc. and the like.

Excel File—The term “Excel file” refers to a type of spreadsheet data file generated by the Microsoft Excel spreadsheet program. Spreadsheets present tables of values arranged in rows and columns that can be manipulated mathematically.

File Import—The term “file import” refers to a simultaneous, across-the-board update of all products listed on the seller's shopping web site. Such updates are generally performed by importing product prices and other properties of a data set via a CSV, Excel, or other type text import file.

Flat File Database—The term “flat file database” refers to a means of storing data items as a single file. There are usually no structural relationships between individual records.

Grouped Product—The term “grouped product” refers to a collection of associated products offered as a group or bundle. For example, a coordinated set grouped by season or theme. A grouped product presents multiple, standalone products as a group. The products can be purchased separately, or as a group. A grouped product is a type of complex product.

Import File—The term “import file” refers to a data set file containing properties and prices of all products listed on the seller's shopping web site. Import files are generally CSV, Excel, or other type text file and are used to perform simultaneous, across-the-board product updates during a file import.

Industry specific—The term “industry-specific” refers to computer programs and data structures appropriate for a specific industry. For example, a pricing program for home building or an estimating program for printing services.

JSON—The term “JSON” (JavaScript Object Notation), refers to an open standard format that uses human-readable text to transmit data objects consisting of attribute-value pairs. It is used primarily as an alternative to XML to transmit data between a server and web application.

Listing price—The term “listing price” or just “price” refers to the price of a web product displayed on a seller's shopping web site.

Mandatory Data Field—The term “mandatory data field” refers to a column or field in the web products database that must contain a value. Vendors of shopping cart software equipped for file imports typically publish a list of mandatory data fields required for file imports into their software. Due to the absence of standards, the list of mandatory data fields tends to be different for each vendor.

Manual Worksheet—The term “manual worksheet” refers to a worksheet that contains listing prices and rules for entering a web product manually, via a keyboard for example, into a seller's shopping web site.

Master—The term “master” refers to a record in the master data records table of the web products database. A master data record contains data objects common to all configurations under its control.

Option—The term “option” refers to a selectable feature, component, or variation of a complex product. For example, a T-Shirt may have size options of small, medium, and large, a hard drive may have capacity options of one terabyte or two terabytes, or a printed product may be ordered with quantity options of 500, 1000, 2500, etc.

Parsing—The term “parsing” refers to the syntactic analysis of a string of symbols and alpha-numeric characters into its component parts to facilitate the writing of data sets.

Partial Update—The term “partial update” refers to an update of one or more selected products on the seller's shopping web site. Changes are performed by manually entering updated prices and other properties directly into the seller's shopping cart software, preferably with the aid of a program-generated worksheet.

Price List—The term “price list” refers to a table of prices that sellers charge for their products. Such prices can be calculated manually but are typically generated with pricing software.

Pricing Software—The term “pricing software” refers to a computer program for pricing a seller's goods or services. Such programs are most commonly custom coded for a specific industry.

Product—The term “product” refers to a good or service which may be offered for sale such as through a web store service or on a web store service website.

Product Management Program—The term “product management program” refers to software that controls the pricing and other displayed properties of products on the seller's shopping web site.

Product Properties—The term “product properties” refers to prices, specifications, images, and other data descriptive of a product.

Product with Options—The term “product with options” refers to a product offered with choices such as size, color, gender, of shoes or belts. Each option represents a separate, simple product with a unique identifier such as a distinct SKU, which makes it possible to track inventory for each option of a product with options. A product with options is a type of complex product.

Publication—The term “publication” refers to the act of publishing prices and other properties of web products on a shopping web site.

Relational Database—The term “relational database” refers to a collection of tables of data items that have defined relationships with each other. Each table must include a primary key (customer ID, serial number) to uniquely identify each row. A relationship can then be established between each row in that table and a row in another table.

Rule—The term “rule” refers to an algorithm or instructions used to control pricing behavior of a computer software implementation of the present invention. For example, the algorithm or instructions “If color=blue, add $2.50” or “If color=blue and size=large, price=$13.00” would be classified as rules.

Sales History—The term “sales history” refers to the number of times a product was sold during specific time periods.

Seller—The term “seller” refers to a person or entity offering goods or services in an ecommerce environment.

Shopping Cart Software—The term “shopping cart software” refers to ecommerce software on a web server that allows online shopping customers to accumulate a list of items for purchase. Upon checkout, the software typically calculates a total for the order, including shipping and taxes, as applicable.

Shopping Website—The term “shopping website” refers to a website utilizing shopping cart software, catalog order-taking facility, or other ecommerce environment that allows customers to purchase products via the internet.

Simple Product—The term “simple product” refers to a standalone product offered without options or other configurations. If a product is not a simple product than it is classified as a complex product.

SKU—The term “SKU” (stock keeping unit) refers to a string of alpha and/or numeric characters that uniquely identify a product. Often portrayed as a machine-readable bar code, assigning an SKU to a product allows that product to be tracked for inventory.

Standard Configuration—The term “standard configuration” refers to the base configuration of a complex product. For example, a computer equipped with a 10 gigabyte hard drive may be the standard configuration for that computer. The same computer equipped with a 20 gigabyte hard drive would represent an optional configuration of that complex product.

Stock on Hand—The term “stock on hand” refers to the quantity currently in inventory of a particular good or material that a business holds for the ultimate purpose of resale.

Table—The term “table” refers to an organized set of data elements in a database, using a model of vertical columns and horizontal rows.

Vendor specific—The term “vendor specific” refers to unique properties of data structures and algorithms underlying the shopping cart software from specific vendors. For example, rules formatted to meet file import requirements of specific shopping cart software.

XML—The term “XML” (Extensible Markup Language) refers to a computer language that defines a set of rules for encoding documents in a format that is both human-readable and machine-readable.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New systems and methods for managing prices and descriptions of products on a shopping website are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Conventional methods for importing prices and other properties of products into shopping cart software are difficult and time-consuming. In the absence of standards, shopping website service providers have developed proprietary data structures and techniques for importing web products into their shopping cart software. This applies not only to manual entry, one product at a time, but also to importing products more efficiently in bulk file imports via CSV, Excel, XML or other type import files.

In some embodiments, methods for managing prices and descriptions of products on a shopping website may provide for managing the pricing and publication of products on a regular basis. In further embodiments, methods for managing prices and descriptions of products on a shopping website may provide sellers of products an easy to use, efficient method to convert prices and other properties of web products into vendor-specific data sets. Such data sets are stored in a database maintained by the seller separate from the shopping cart software, allowing the seller to import web products in bulk into commercial shopping cart software offered by a plurality of vendors. Because each data set is constructed by the present invention to conform to the proprietary data structure and import technique mandated by each individual vendor, sellers are further provided with the ability to easily transfer their web products into shopping cart software from another vendor should that vendor's software and support better serve their requirements.

A significant downside to updating web products with import files is that such files are typically all inclusive. As a result, even a single price change of a single web product may import all prices and properties of all web products, overwriting any partial updates the seller may have made in the interim. The present invention is designed to eliminate the risk of overwriting partial updates by storing all changes in an intermediate web products database maintained by the seller separate from the shopping cart software. Changes that need to be made to the price or other property of a web product, no matter how they are to be implemented, whether by partial update or by file import, are first saved in the web products file from where they are then imported into the seller's shopping cart software at a time and date convenient to the seller. Among other benefits, the strategy of physically separating the act of updating a web product from the time and date of actually importing the changes into the seller's shopping cart software makes both the method and the time and date of the import irrelevant to the validity of the data.

For example, when a price discrepancy is discovered on the seller's shopping web site, the correction can be made immediately via a partial update without having to wait for the next general file import. A file import will of course overwrite this price correction, but since values used for file imports and for partial updates are both retrieved from the same web products file, the file import will overwrite the new, already corrected price on the seller's shopping web site with an identically corrected price saved during the partial update in the web products file. If a partial update was initiated but not carried to completion with a manual upload, the changes will of course not be reflected on the seller's shopping web site. They will, however, be automatically uploaded during the next file import and reflected at the completion of the import.

It is common practice for sellers to discount prices of product configurations that are in oversupply. The present invention is directed to managing, on a regular basis, price reductions for product configurations when the quantity on hand of such configurations reaches a predetermined level set by the seller.

In an ecommerce environment, it is generally desirable to display the most sought after configuration of a complex web product as the default configuration, for the same reason that the best-selling version of a physical product is usually given preferred placement in a physical store. For example, if blue T-Shirts are found to outsell other colors, it is to the seller's advantage to keep a blue T-Shirt on more prominent display than other colors. The present invention is directed to managing the initial display of complex web products on the seller's shopping web site on a regular basis.

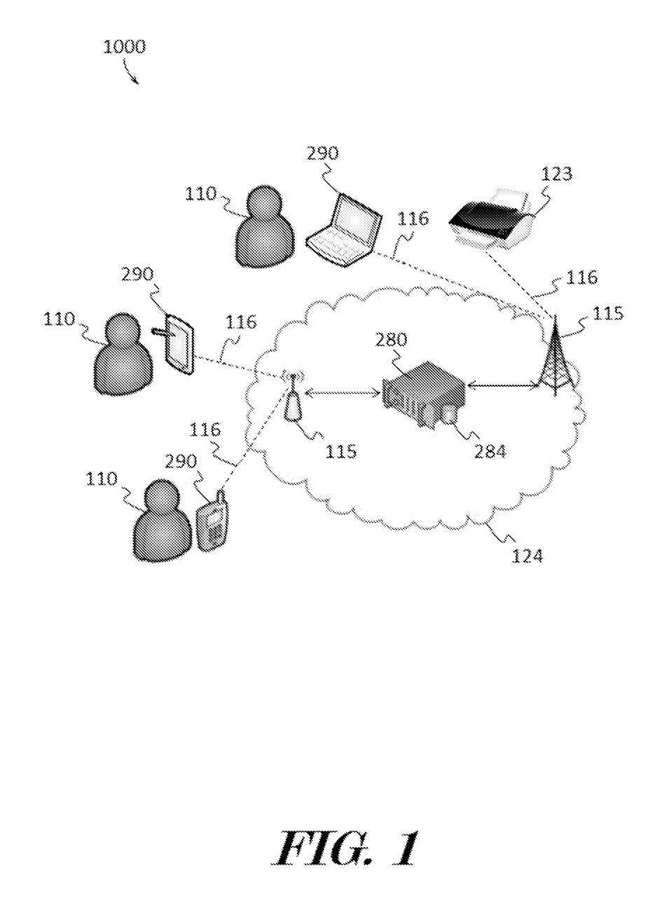

The present invention will now be described by example and through referencing the appended figures representing preferred and alternative embodiments. As perhaps best shown by FIG. 1, an illustrative example of some of the physical components which may comprise a system for managing prices and descriptions of products on a shopping website, “the system” 1000, according to some embodiments is presented. The system 1000 is configured to facilitate the transfer of data and information between one or more access points 115, client devices 290 and servers 280 over a data network 124 with one or more databases on a data store 284 accessible by a server 280. In this example, the system 1000 comprises at least one client device 290 (but preferably more than two client devices 290) configured to be operated by one or more users 110. Client devices 290 can be mobile devices such as laptops, personal digital assistants, smart phones, or fixed devices such as desktops and workstations that are equipped with a wired or wireless network connection 116 capable of sending data to one or more servers 280 with access to one or more data stores 284 over a network 124.

In general, the present invention involves one or more computers or other type of client device 290 used by a user 110, in communication with one or more computers being operated by an online web site which is offering products for sale such as goods and services. Communication between the two computers preferably occurs via the internet, but it is contemplated that such communication may occur in any suitable manner. The precise method of communication used between the various computers is not intended to be limiting, nor is the communication protocol used by the various computers. The present invention is limited only by the claims presented below, and not by exemplary hardware described herein.

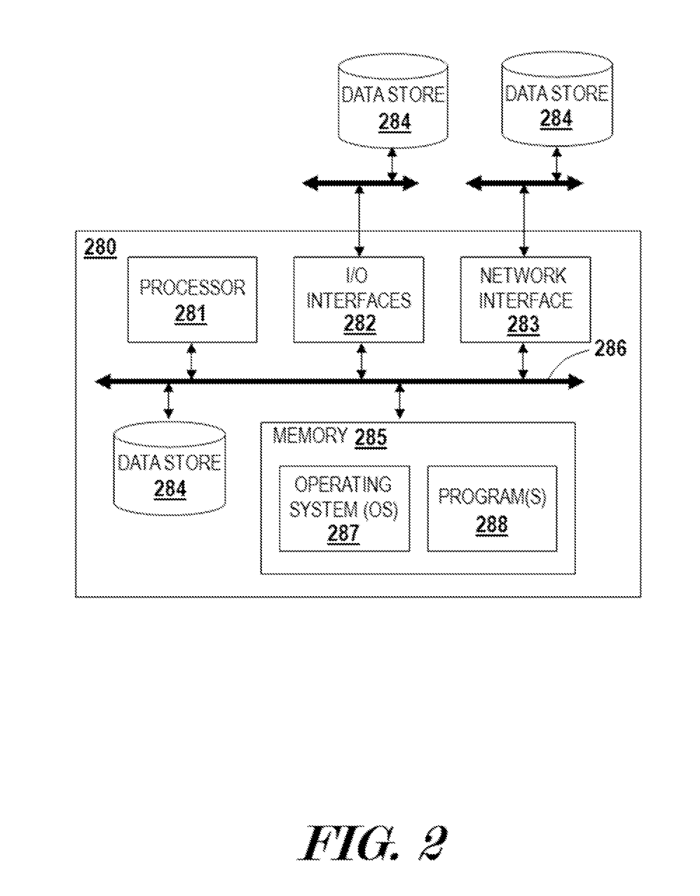

Referring to FIG. 2, in an exemplary embodiment, a block diagram illustrates a server 280 which may be used in the system 1000, in other systems, or standalone. The server 280 may be a digital computer that, in terms of hardware architecture, generally includes a processor 281, input/output (I/O) interfaces 282, a network interface 283, a data store 284, and memory 285. It should be appreciated by those of ordinary skill in the art that FIG. 2 depicts the server 280 in an oversimplified manner, and a practical embodiment may include additional components and suitably configured processing logic to support known or conventional operating features that are not described in detail herein. The components (281, 282, 283, 284, and 285) are communicatively coupled via a local interface 286. The local interface 286 may be, for example but not limited to, one or more buses or other wired or wireless connections, as is known in the art. The local interface 286 may have additional elements, which are omitted for simplicity, such as controllers, buffers (caches), drivers, repeaters, and receivers, among many others, to enable communications. Further, the local interface 286 may include address, control, and/or data connections to enable appropriate communications among the aforementioned components.

The processor 281 is a hardware device for executing software instructions. The processor 281 may be any custom made or commercially available processor, a central processing unit (CPU), an auxiliary processor among several processors associated with the server 280, a semiconductor-based microprocessor (in the form of a microchip or chip set), or generally any device for executing software instructions. When the server 280 is in operation, the processor 281 is configured to execute software stored within the memory 285, to communicate data to and from the memory 285, and to generally control operations of the server 280 pursuant to the software instructions. The I/O interfaces 282 may be used to receive user input from and/or for providing system output to one or more devices or components. User input may be provided via, for example, a keyboard, touch pad, and/or a mouse. System output may be provided via a display device and a printer (not shown). I/O interfaces 282 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 283 may be used to enable the server 280 to communicate on a network, such as the Internet, a wide area network (WAN), a local area network (LAN), and the like, etc. The network interface 283 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 283 may include address, control, and/or data connections to enable appropriate communications on the network. A data store 284 may be used to store data. The data store 284 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 284 may incorporate electronic, magnetic, optical, and/or other types of storage media. In one example, the data store 284 may be located internal to the server 280 such as, for example, an internal hard drive connected to the local interface 286 in the server 280. Additionally in another embodiment, the data store 284 may be located external to the server 280 such as, for example, an external hard drive connected to the I/O interfaces 282 (e.g., SCSI or USB connection). In a further embodiment, the data store 284 may be connected to the server 280 through a network, such as, for example, a network attached file server.

The memory 285 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 285 may incorporate electronic, magnetic, optical, and/or other types of storage media. Note that the memory 285 may have a distributed architecture, where various components are situated remotely from one another, but can be accessed by the processor 281. The software in memory 285 may include one or more software programs, each of which includes an ordered listing of executable instructions for implementing logical functions. The software in the memory 285 includes a suitable operating system (O/S) 287 and one or more programs 288. The operating system 287 essentially controls the execution of other computer programs, such as the one or more programs 288, and provides scheduling, input-output control, file and data management, memory management, and communication control and related services. The one or more programs 288 may be configured to implement the various processes, algorithms, methods, techniques, etc. described herein.

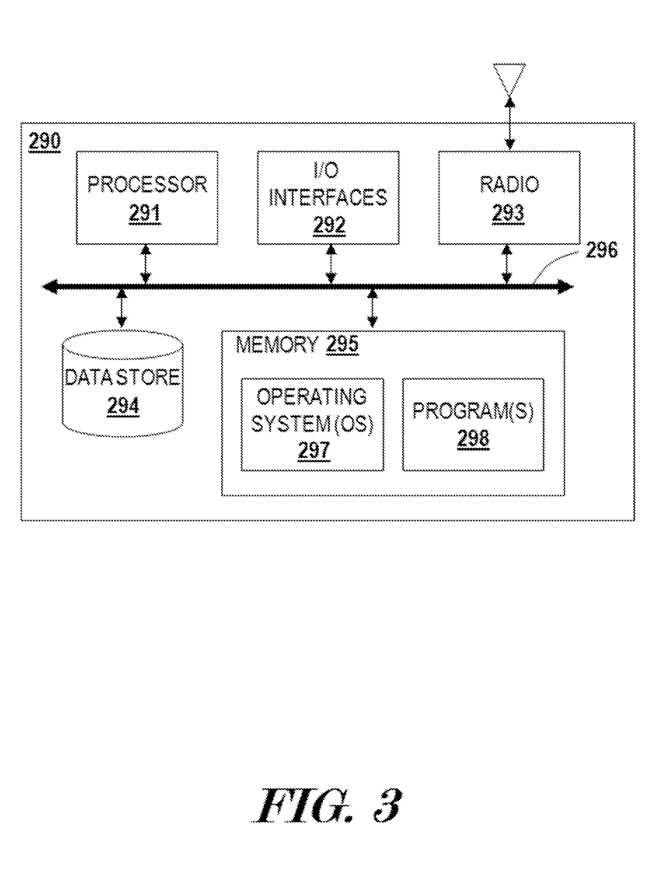

Referring to FIG. 3, in an exemplary embodiment, a block diagram illustrates a client device 290, which may be used in the system 1000 or the like. The client device 290 can be a digital device that, in terms of hardware architecture, generally includes a processor 291, input/output (I/O) interfaces 292, a network interface 293 such as a radio, a data store 294, and memory 295. It should be appreciated by those of ordinary skill in the art that FIG. 3 depicts the client device 290 in an oversimplified manner, and a practical embodiment may include additional components and suitably configured processing logic to support known or conventional operating features that are not described in detail herein. The components (291, 292, 293, 294, and 295) are communicatively coupled via a local interface 296. The local interface 296 can be, for example but not limited to, one or more buses or other wired or wireless connections, as is known in the art. The local interface 296 can have additional elements, which are omitted for simplicity, such as controllers, buffers (caches), drivers, repeaters, and receivers, among many others, to enable communications. Further, the local interface 296 may include address, control, and/or data connections to enable appropriate communications among the aforementioned components.

The processor 291 is a hardware device for executing software instructions. The processor 291 can be any custom made or commercially available processor, a central processing unit (CPU), an auxiliary processor among several processors associated with the client device 290, a semiconductor-based microprocessor (in the form of a microchip or chip set), or generally any device for executing software instructions. When the client device 290 is in operation, the processor 291 is configured to execute software stored within the memory 295, to communicate data to and from the memory 295, and to generally control operations of the client device 290 pursuant to the software instructions. In an exemplary embodiment, the processor 291 may include a mobile optimized processor such as optimized for power consumption and mobile applications. The I/O interfaces 292 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 292 can also include, for example, a serial port, a parallel port, a small computer system interface (SCSI), an infrared (IR) interface, a radio frequency (RF) interface, a universal serial bus (USB) interface, and the like. The I/O interfaces 292 can include a graphical user interface (GUI) that enables a user to interact with the client device 290. Additionally, the I/O interfaces 292 may further include an imaging device, i.e. camera, video camera, etc.

The network interface 293 may enable wired communication to an external access device or network and/or may comprise a radio which enables wireless communication to an external access device or network. Any number of suitable wireless data communication protocols, techniques, or methodologies can be supported by the network interface 293, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 294 may be used to store data. The data store 294 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 294 may incorporate electronic, magnetic, optical, and/or other types of storage media.

The memory 295 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 295 may incorporate electronic, magnetic, optical, and/or other types of storage media. Note that the memory 295 may have a distributed architecture, where various components are situated remotely from one another, but can be accessed by the processor 291. The software in memory 295 can include one or more software programs, each of which includes an ordered listing of executable instructions for implementing logical functions. In the example of FIG. 3, the software in the memory 295 includes a suitable operating system (O/S) 297 and programs 298. The operating system 297 essentially controls the execution of other computer programs, and provides scheduling, input-output control, file and data management, memory management, and communication control and related services. The programs 298 may include various applications, add-ons, etc. configured to provide end user functionality with the client device 290. For example, exemplary programs 298 may include, but not limited to, a web browser, social networking applications, streaming media applications, games, mapping and location applications, electronic mail applications, financial applications, and the like. In a typical example, the end user typically uses one or more of the programs 298 along with a network such as the system 1000.

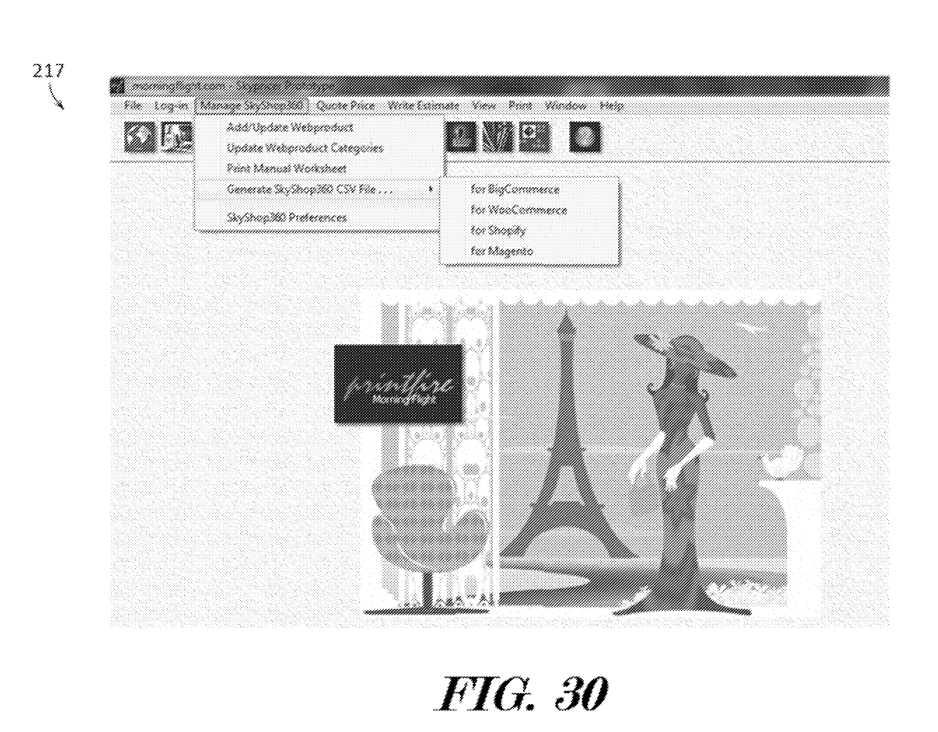

Example embodiments of the present invention will now be described with reference to FIGS. 1-32.

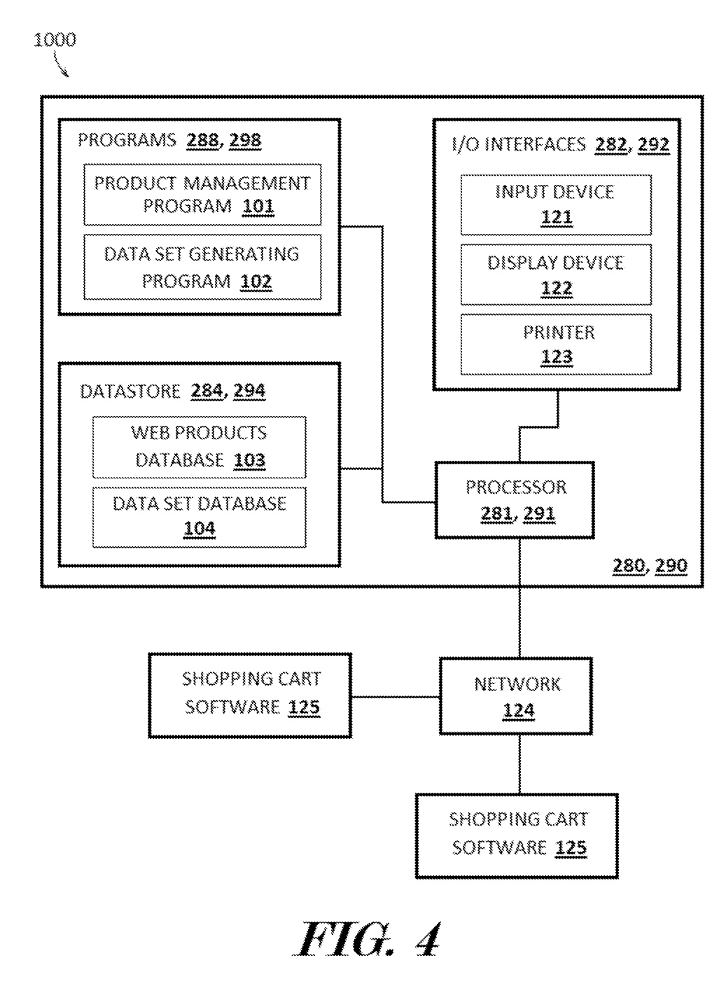

Referring now to FIGS. 1 and 4, the present invention may be implemented on at least one client device 290 and/or server 280 programmed to perform one or more of the steps described herein. In some embodiments, more than one client device 290 and/or server 280 may be used, with each being programmed to carry out one or more steps of a method or process described herein. Such client devices 290 may be general purpose computers, such as a desktop computer used by the seller to manage the price of products listed on a shopping web site. It is contemplated, however, that any suitable computer may be used with any suitable computer being any computer that is capable of being programmed to perform one or more steps of a method or process described herein. Such computers include, but are not limited to, desktop computers, laptop computers, tablet computers, servers, cellular phones, and the like. The system 1000 may be in communication with one or more instances of shopping cart software 125 which may be used to generate components of one or more internet shopping websites. The system may be configured to manage prices and descriptions of products offered for sale on a shopping website utilizing shopping cart software 125.

The system 1000 may comprise a data store 284, 294, which includes a product management program 101 and a data set generating program 102 for controlling the processor 281, 291. The programs 288, 298, and data store 284, 294 are accessible by the processor 281, 291 such as through a local interface 286, 296 (FIGS. 2 and 3), and/or a network 124. Connected to the processor 281, 291, are conventional I/O interfaces 282, 292 (FIGS. 2 and 3), such as an input device 121, a display device 122, and a printer 123. The processor 281, 291 is in communication with a data store 284, 294, and performs instructions relayed to it by programs 288, 298, such as the product management program 101 and the data set generating program 102.

In some embodiments, the system 1000 may communicate with shopping cart software 125 which offers an API (application programming interface) to the resources and events that represent common activities, such as additions to prices and descriptions of products, changes to prices and descriptions of products, and removals of products, on its respective shopping web site. Where an API is present, such activities can be performed in real time between the system 1000 and shopping cart software 125 through a network 124. In further embodiments, it is contemplated that the shopping cart software 125 would maintain a database to store prices and descriptions of products for sale on its respective shopping web site.

The product management program 101 and data set generating program 102 may be stored in a client device 290 and/or server 280 allowing a processor 281 of a server 280 and/or a processor 291 of a client device 290 to perform operations of the product management program 101 and/or data set generating program 102. Similarly, data bases, such as a web products database 103 and a data set database 104, may be stored in a data store 294 of a client device 290 and/or a data store 284 of a server 280 allowing a processor 281 of a server 280 and/or a processor 291 of a client device 290 to read and write data to the web products database 103 and/or data set database 104. The databases 103 and 104 are described in detail below and depicted with exemplary entries in the accompanying figures. As will be understood by those skilled in the art, the schematic illustrations and accompanying descriptions of the databases presented herein are exemplary arrangements for stored representations of information. A number of arrangements other than those suggested by the databases shown may be employed. Similarly, the illustrated entries of the databases represent exemplary information, and those skilled in the art will understand that the number and content of the entries can be different from those illustrated herein.

In some embodiments, a web products database 103 may store pricing and other description information and data for all configurations and options of both complex and simple products to be sold on the shopping web site. Such information may include, but is not limited to, product identifiers, the name of the product, its SKU, description, listing price, and other relevant information such as weight, size, color, inventory on hand, and sales history. The web products database 103 preferably includes data or values for all mandatory data fields required for a first shopping cart software 125, but also includes data or values for all mandatory data fields required for a second shopping cart software 125. In further embodiments, the web products database 103 preferably includes data or values for all mandatory data fields required for one or more shopping cart software programs 125, such as a plurality of shopping cart software programs 125.

In some embodiments, a data set database 104 may store data sets generated by a data set generator program 102 using information stored in the web products database 103. Such data sets may be stored as comma-delimited text files and/or may be stored in any suitable file format or data structure required by the shopping cart software 125 of one or more individual shopping cart vendors. Each data set may be unique in that it may be formatted to match the exact data structure required by the shopping cart software 125 of one or more individual shopping cart vendors.

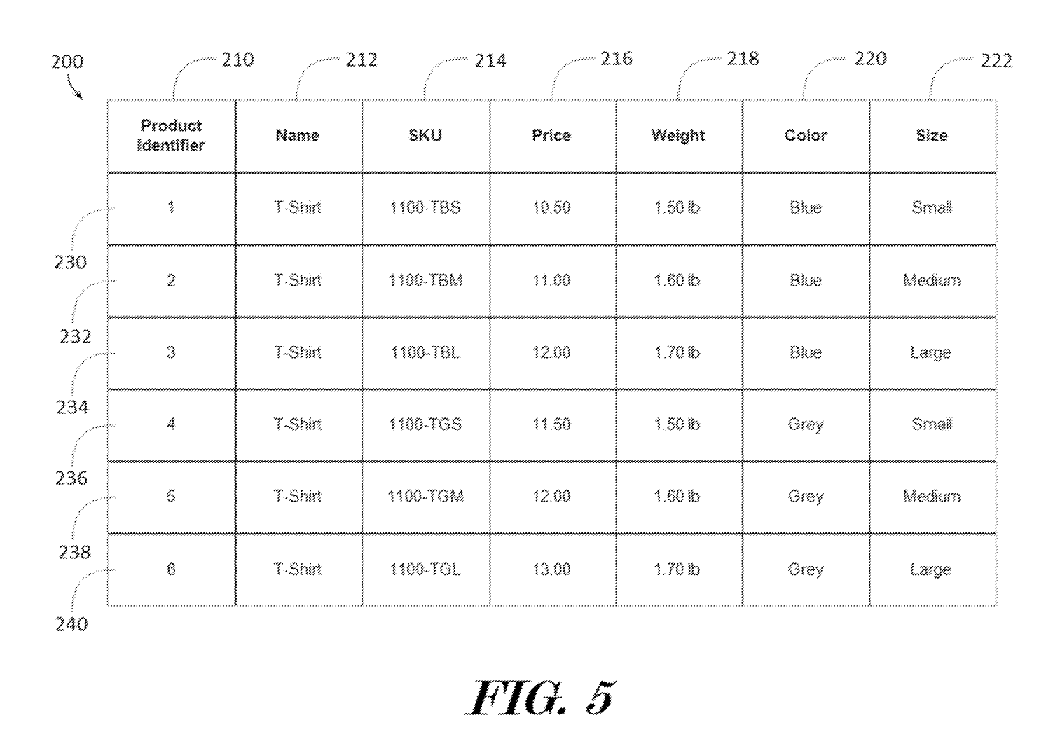

FIG. 5 illustrates a prior art database 200 in which the data is organized according to a prior art data structure. The data structure includes a product identifier data object 210, a name data object 212, an SKU data object 214, a price data object 216, a weight data object 218, a color data object 220, and a size data object 222. The product identifier 210 uniquely identifies the product. The name, SKU, price, weight, color, and size specify the product's name, SKU, price to pay, weight, color, and size. Each of records 230, 232, 234, 236, 238, and 240 represent a different product with its own unique identifier, name, SKU, price to pay, weight, color, and size. Typically, conventional shopping cart software 125 (FIG. 4) uses the product identifier data object 210 to locate and retrieve the price stored in the price data object 216. It then applies the retrieved price for the product to the transaction.

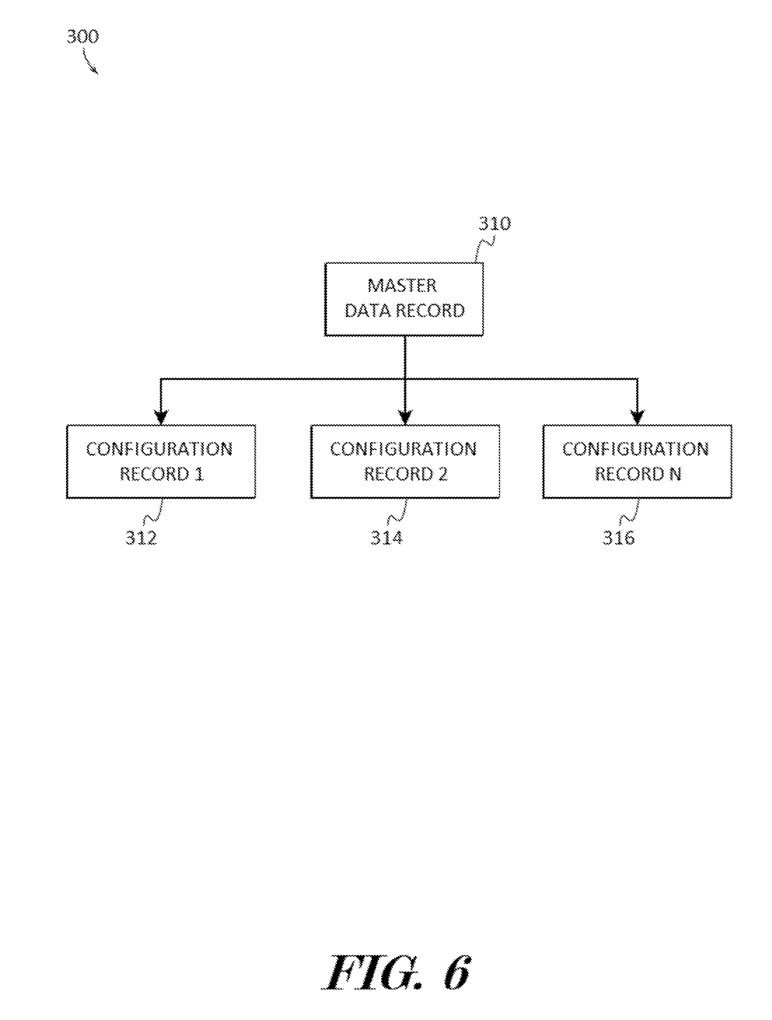

FIG. 6 shows a block diagram depicting an example database 300 in which the data is organized according to various embodiments described herein. In some embodiments, such data is stored on a computer-readable medium and may be accessible by the product management program 101 and the data set generating program 102 described herein. In some embodiments, the database 300 may comprise a mater data record 310 for each product which may be stored in a web products data base 103 (FIG. 4) and which further comprises one or more configuration records such as a first configuration record 312, a second configuration record 314, up to an Nth configuration record 316. A first configuration record 312 may contain data on a simple product, with no selectable options, or it may contain a first configuration of a configurable product, with one or more selectable options. A master data record 310 comprising a second configuration record 314 may contain a second configuration of a configurable product, with one or more selectable options, while an Nth configuration record 316 may contain a second configuration of a configurable product, with any number (N) of selectable options.

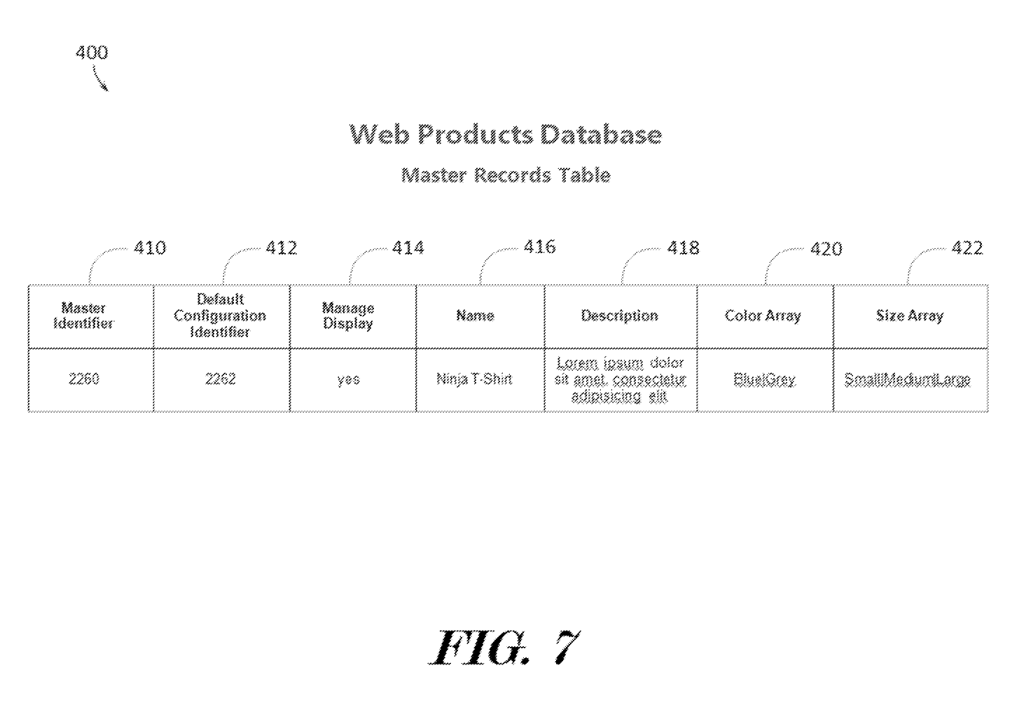

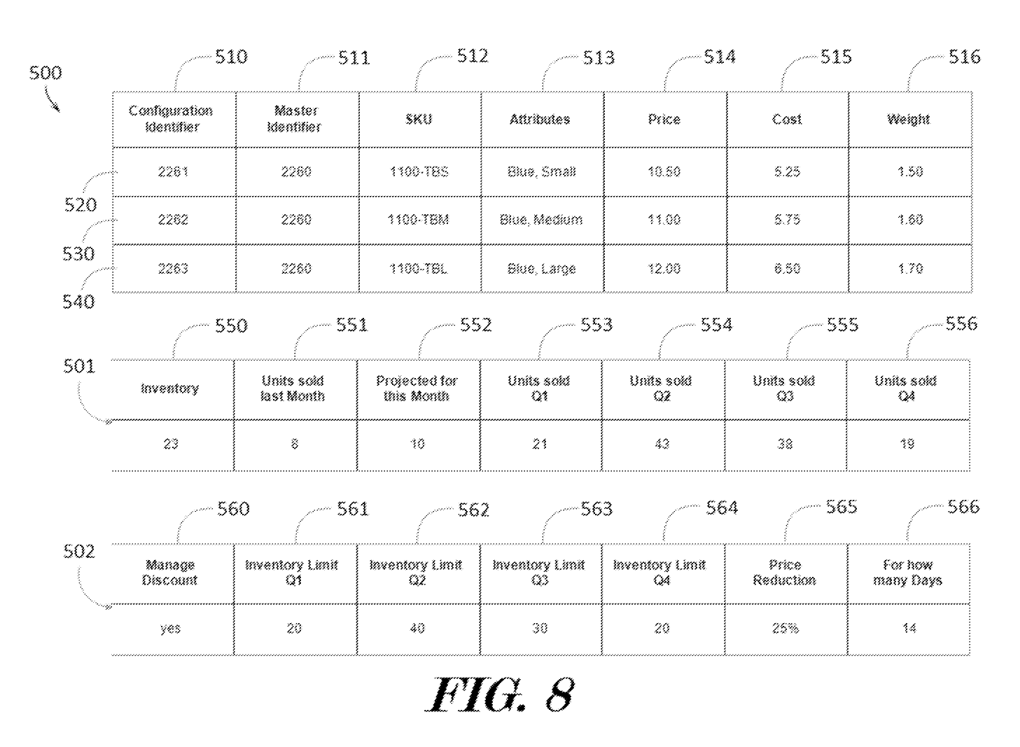

FIG. 7 depicts an example of a master data record 310 comprising a plurality of data fields 410, 412, 414, 416, 418, 420, 422, etc. which are graphically shown in a master records table 400 of database 300 of FIG. 6 storing illustrative data while FIG. 8 illustrates an example of the configuration records table of database of FIG. 6 storing illustrative data according to various embodiments described herein. FIGS. 7 and 8 depict the database 300 of FIG. 6 storing illustrative clothing data. The web products database 103 structure includes a master records table 400 and a configuration records table 500. Table diagrams identified by reference numerals 501 and 502 in FIG. 8 represent portions of the configuration records table 500 for ease of illustration.

The master data records table 400 (FIG. 7) contains a plurality of records. Each master record contains values common to configurations controlled by it. The record may include a master identifier data field 410, a default configuration identifier data field 412, a manage display data field 414, a name data field 416, a description data field 418, one or more attribute set data field 420-422 containing one or more options which may be selected to make a configuration of a configurable product, although other data fields may also be included. The master identifier 410 uniquely identifies a master record. The default configuration identifier 412 identifies the configuration of a configurable product to be displayed as the default configuration on the seller's shopping web site. The manage display 414 is manipulated by the seller to control whether the selection process of the default configuration is to be managed by the product management program 101 (FIG. 4). The name 416 and description 418 are properties shared by all configurations controlled by a specific master data record 310. Each attribute set 420, 422, defines options available for a specific configuration, and at the same time restricts the selectable options to those values. For example, the size array attribute set 422 in the master data record 310 illustrated in master records table 400 allows any configuration controlled by the master data record 310 with name data 416 “Ninja T-Shirt” to be listed with a size option of small, medium, or large. Before any configuration controlled by that master data record 310 can be listed with a size option of extra-large, the attribute set 422 in the master records table 400 must be expanded to include an “extra-large” attribute. Conversely, the inclusion of an attribute in an attribute set does not require that a configuration with an option matching that attribute be available. The order in which attributes are arranged in each set may define the order in which the respective options are presented on the seller's shopping web site. The illustrative display of attribute sets is of the CSV file type, but it may be stored in XML, JSON, or other convenient format.

The configuration records table 500 (FIG. 8) contains a plurality of records, each containing values specific to a unique configuration of a configurable product. All master data records 310 may have one or more associated configurations. The presence of only one associated configuration signifies that the product is simple, without options. Preferably, no configuration record 312, 314, 316, can be linked to more than one master data record 310. In relational database terminology, the master records data table 400 (FIG. 7) and configuration records table 500 are said to be in a one-to-many relationship.

The configuration records table 500 may include, among other data fields, a configuration identifier data field 510, a master identifier data field 511, an SKU data field 512, an attributes data object 513, a price data object 514, a cost data object 515, and a weight data object 516. The configurations identifier 510 may uniquely identify a configuration. The master identifier 511 may enable the product management program 101 and the data set generating program 102 (FIG. 4) to link configurations to their respective master record 310 by accessing only configurations where the master identifier 511 in the configuration records table 500 matches the master identifier 410 in the master records data table 400. For example, only configurations with a value of “2260” in master identifier field 511 of the configuration records table 500 may be listed as options for the master identified as “2260” in master identifier data field 410 of master records table 400.

The SKU data object 512 specifies a unique stock keeping unit for inventory control purposes. The attributes data object 513 identifies the totality of attributes for this product. The price data object 514 specifies the listing price for this product. The cost data object 515 specifies the seller's cost for this product, and the weight data object 516 specifies its weight to facilitate the calculation of shipping costs.

The configuration identifier data object 510 and master identifier data object 511 may be controlled by the product management program 101 (FIG. 1). Values for the SKU data object 512, attributes data object 513, cost data object 515, and weight data object 516 are provided by the seller. The value for price data object 514 is generally provided by the seller, but can also be provided by an integrated prior art pricing program, or be controlled by the product management program 101. For example, to lower the listing price of overstocked items as described below.

For illustrative purposes, the configuration identified by configuration identifier data field 530 with a value of 2262 has a price of “$11.00” for a “Ninja T-Shirt”, color “Blue”, size “Medium”, which may optionally represent the default configuration for master record “2260”. When the buyer selects “Large” instead of “Medium”, the shopping cart software 125 may retrieve from the web products database 103 the single, unique configuration identified by configuration identifier data field 540 with a value of 2263, showing a master identifier 511 of “2260”, attributes 513 of “Blue, Large”, and a price 514 of “$12.00”. The order in which the buyer selects these options is immaterial and will not affect the value of the final listing price.

Also included in the configuration records table 500 and illustrated in the diagram identified by reference numeral 501 is an inventory data object 550, which may show the current number of units on hand for a configuration of a configurable product. Inventory may accessed by the product management program 101 (FIG. 1) to manage the listing prices of overstocked items as described below.

Also included in the diagram identified by reference numeral 501 are data fields 551, 552, 553, 554, 555, and 556 that may be accessed by the product management program 101 to determine which of the available configurations of a complex product is to be displayed as the default configuration on the seller's shopping web site. The values for “units sold last month” data field 551 and “projected for this month” data field 552 may be retrieved from the shopping cart software 125 (FIG. 4) at regular intervals. In a preferred embodiment, the number of units projected for this month may be added to the number of units sold last month for each of the configurations of a respective master record. If the value in the manage display data object 414 (FIG. 7) is “yes”, the configuration with the highest number of units sold may then be selected as the default configuration for that master record 310. For example, the illustrative value of “2262” in the default configuration identifier data object 412 (FIG. 7) shows the configuration identified as 530 in configuration identifier data object 510 (FIG. 8) to be the default configuration for the master record 310 with master identifier “2260”. If a retrieval of current data should show that the configuration identified as 540 recorded the highest number of units sold during the cumulative period, the product management program 101 may change the value stored in the default configuration identifier data object 412 to “2263”. In some embodiments, storing the default configuration identifier 412 in the master records data table 400 assures that for each master record 310, only a single configuration can be designated as the default configuration.

The following is an example of a formula that could be applied to calculate the value of the projected for this month data object 552:

UnitsSold=UnitsJanuary+(UnitsFebruary/30×FebruaryDaysToDate)

It is contemplated that, in one embodiment of the present invention where sales are not subject to rapid fluctuations, the selection process may be based on simply comparing sales in one or more calendar quarters (data fields 553, 554, 555, 556).

Also, in some embodiments, included in the configuration records table 500 and illustrated in the diagram identified by reference numeral 502 are data objects 560, 561, 562, 563, 564, 565, and 566 which may be accessed by the product management program 101 (FIG. 4) to determine whether the listing price of a specific configuration should be reduced to promote a reduction in inventory. The “manage discount” data object 560 is manipulated by the seller to control whether the price reduction process is to be managed by the product management program 101 or manually by the seller. The value for inventory data object 550 is retrieved from the shopping cart software 125 at regular intervals. The illustrative data in FIG. 8 shows it to be retrieved quarterly, but in other embodiments, the value may be retrieved monthly or on any other convenient time schedule. All of the remaining data objects 561, 562, 563, 564, 565, and 566 may be manipulated by the seller. The values in data objects 561-564 may specify maximum limits for units on hand that, if exceeded AND the value in the manage discount data object 560 is “yes”, will cause the product management program 101 to lower the listing price for the respective configuration. The value in data object 565 species the amount, in terms of currency or percentage, of the price reduction, while the value in data object 566 species the duration. For example, the illustrative data in FIG. 8 mandates that if at the end of the first calendar quarter (Q1) but before the end of the second calendar quarter (Q2), the inventory exceeds “20” units, the product management program 101 will reduce the listing price for the respective configuration by “25%” for the next “14” days. Of course it is understood that tracking of inventory levels could be performed at more frequent intervals to accommodate seasonal products or products consumed by a specific industry.

It is contemplated that data fields may be added or omitted to accommodate specific applications. Conversely, some of the included data fields such as size, color, and weight may not be relevant for all types of products. The illustrated example represents exemplary information, and those skilled in the art will understand that the number and content of the entries can be different from those illustrated herein.

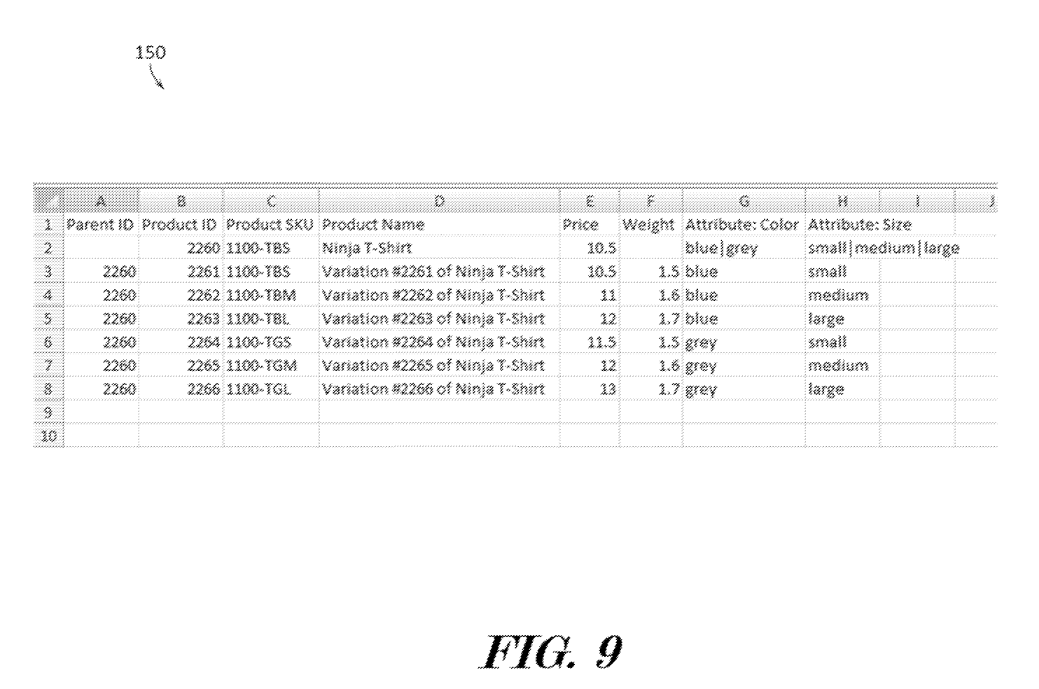

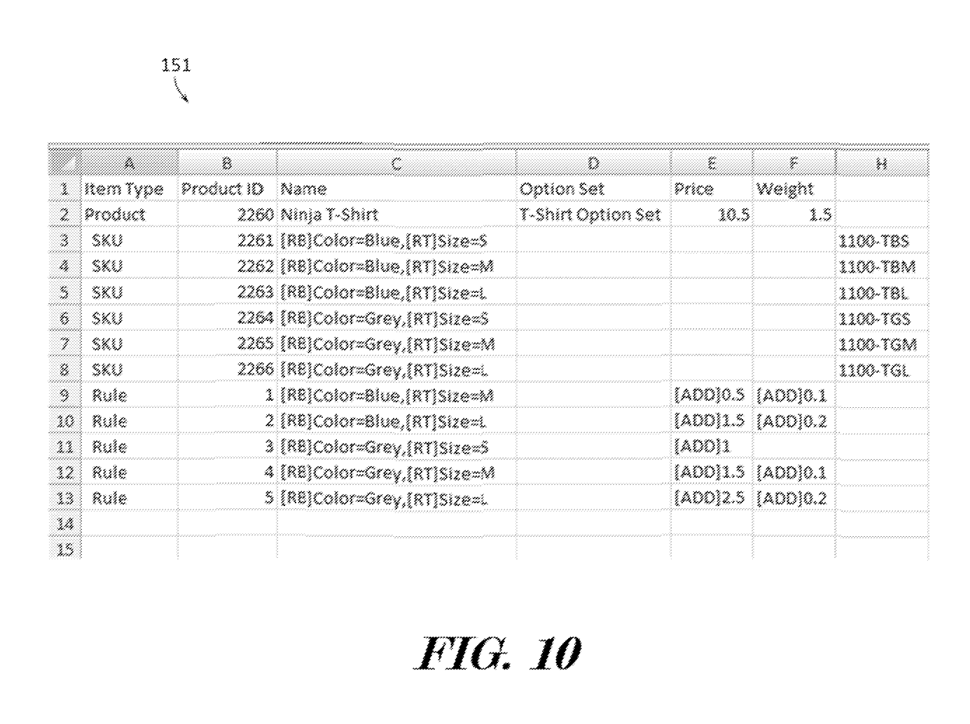

In a shopping web site, price and other attributes of a configurable product may be typically controlled by rules developed by the various shopping cart vendors. In the absence of standards for such rules, the format and implementation varies widely between vendors and should be considered proprietary to each shopping cart software vendor. For example, FIG. 9 illustrates an Excel data file 150 in a format required to import the T-Shirt example illustrated in FIGS. 7 and 8 into an examplary shopping cart software “WooCommerce.” FIG. 10 illustrates an Excel data file 151 in a format required to import the same T-Shirt example illustrated in FIGS. 7 and 8 into the shopping cart software “BigCommerce.” It will be apparent to those skilled in the art that the data file configured for “WooCommerce” cannot be used to import products into the shopping cart software “BigCommerce,” nor can the data file configured for “BigCommerce” be used to import products into the shopping cart software “WooCommerce.” The two data files are uniquely structured for each vendor and thus incompatible.

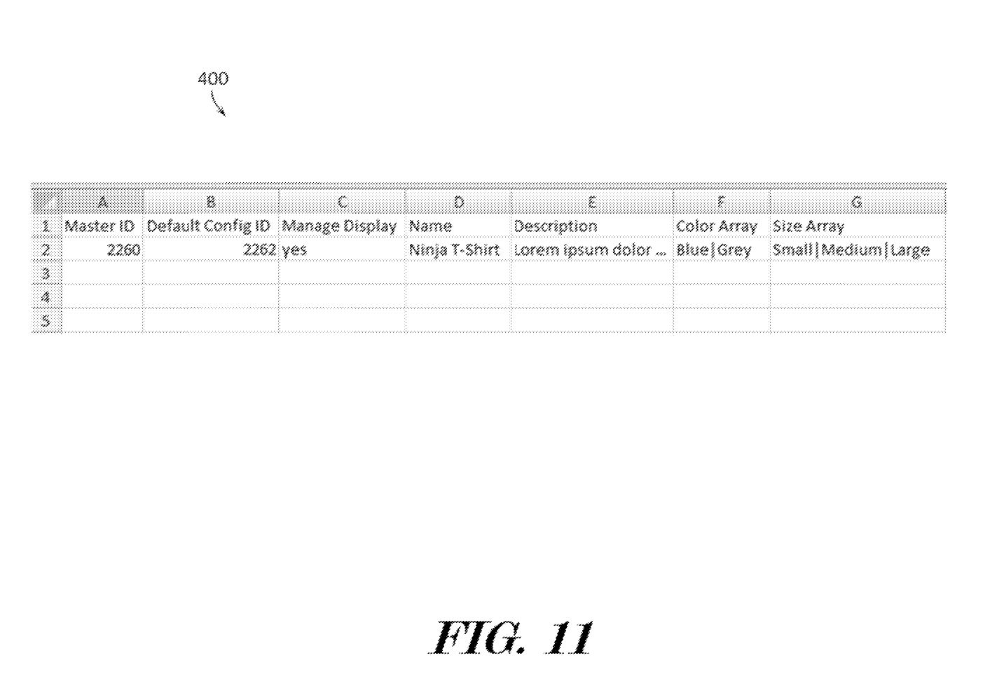

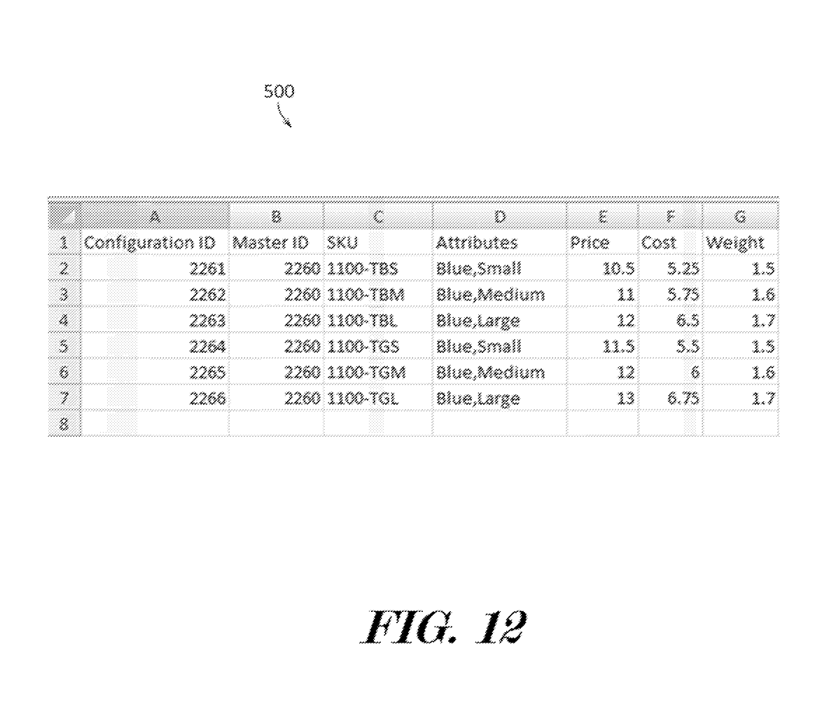

In a preferred embodiment, the web products database 103 (FIG. 4) may be managed by the product management program 101. The web products database 103 may include prices and other product information enabling the data set generating program 102 to create data sets uniquely structured for a plurality of different shopping cart software 125 programs. FIGS. 11 and 12 illustrate example data tables of the web products database 103 for the T-Shirt example illustrated in FIGS. 7 and 8. FIG. 11 depicts an example of a master records table 400. FIG. 12 depicts an example of a configuration records table 500. The generated data sets may be stored in the data set database 104 (FIG. 4). Because the data set database 104 may be used to import products into the seller's shopping cart software 125, it must by necessity be of a file type and format mandated by the seller's shopping cart vendor.

The data tables contained in the web products database 103 may be for the seller's internal use and may be of any convenient file type. They may, however, preferably include data fields for all mandatory data fields required by not only the seller's installed shopping cart software 125, but also by selected alternate shopping cart software 125 programs.

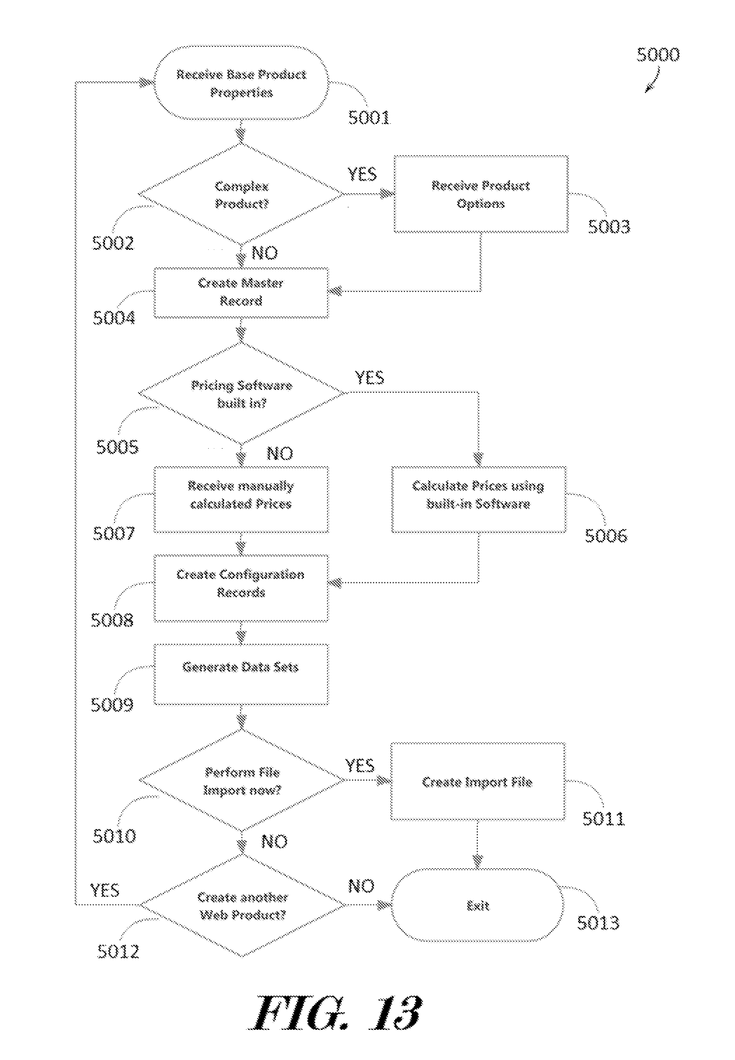

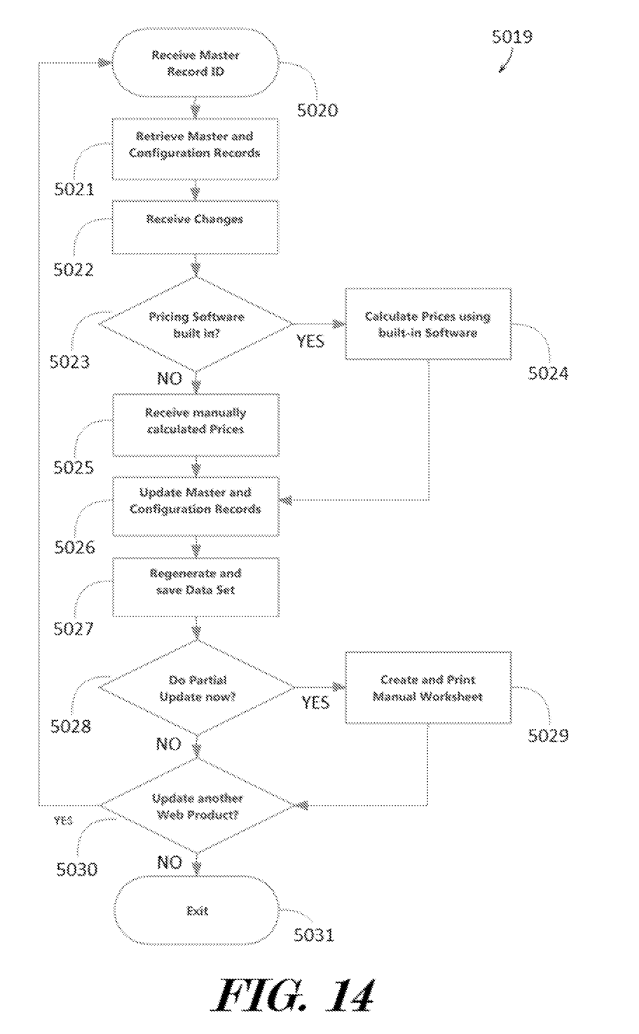

The one or more steps of following flowcharts (FIGS. 13 and 14) are described as being carried out by the product management program 101 with optional input which may be received by an input device 121 (for example a keyboard or flash drive). It is understood that where a process is described as being performed by the input device 121 it could alternately be performed by the product management program 101. Similarly, where a process is described as being performed by the product management program 101 it could alternately be performed by the input device 121. Also, each of the following processes could be performed by a combination of the input device 121, the display device 122, and the product management program 101. For example, the user 110 or seller could enter the cost of a product on a keyboard from where it is transmitted to the product management program 101; the product management program 101 could calculate the seller's markup and transmit the managed listing price back to the seller's display device 122 for approval or modification. The seller could then instruct the product management program 101 via the keyboard to store the approved listing price in the web products database 103.

FIG. 13 depicts a process for entering a new product into a seller's shopping cart software (“the process”) 5000 according to various embodiments described herein. In some embodiments, the process 5000 may be carried out by the product management program 101 with user 110 input received through input device 121 (FIG. 4). Initially, in the process of FIG. 13 base product properties may be received through an input device in step 5001. Typically, the properties may be entered manually using a keyboard for alpha-numeric text and imported image files for photos and illustrations. Of course, properties may also be entered directly from files supplied by the manufacturer or distributor of the web product, or by any other processes.

Following step 5001 is decision block 5002 at which it is determined whether the product is a simple product with no options or a complex product with options. If complex, the product management program executes step 5003 to receive options and variations. If the product is simple, the process may continue to step 5004.

Next, at step 5004, the product management program 101 creates the master data record 310 and stores the record 310 in the master records table 400 of the web products database 103 (FIG. 4). Following step 5004 is decision block 5005 at which it may be determined whether software is available to automatically calculate product and option prices in step 5006. If no pricing software is available, prices may be provided and input by the seller in step 5007 with input device 121 (FIG. 4).

Next, the product management program executes step 5008 to create a configuration record 312, 314, 316, for each configuration of the configurable product. It may then store the created records in the configuration records table 500 of the web products database 103 (FIG. 4). Diagrams identified by reference numerals 501 and 502 in FIG. 8 represent portions of the configuration records table for ease of illustration.

Next, at step 5009, the data set generating program 102 (FIG. 1) first retrieves a master record from the master records table 400 of the web products database, then retrieves all configuration records associated with this master. Using the retrieved data, the data set generating program 102 may then generate a data set in the file format and data structure native to the seller's present shopping cart software, comprising the master record and all its associated configurations.

Following step 5009 is a decision block 5010 at which it may be determined whether the seller intends to perform a file import now, or at a future date when, for example, a general price increase is scheduled to go into effect. If the seller is ready to perform a file import now, in step 5011 the data set generating program, using the data set created in step 5009, may produce an import file suitable for the seller's shopping web site. Advantageously, in some embodiments, the shopping cart software 125 (FIG. 4) may offer an API to the resources and events at the seller's shopping web site. This enables the data set generating program 102 to update the seller's shopping web site directly via an internet connection 124 between the processor 281, 291 and the shopping cart software 125, thus eliminating the need for an import file. Finally, at the decision block 5012, it may be determined whether the seller wants to enter another web product into the web products database 103 (FIG. 4). If so, the process may continue to step 5001. If not, the process may end in 5013.

FIG. 14 illustrates a process for updating an existing product in a seller's shopping cart software (“the process”) 5019 according to various embodiments described herein In some embodiments, the process 5019 may be carried out by a product management program 101 (FIG. 4) with input optionally provided by an input device 121 (FIG. 4) for the purpose of implementing a partial update. Except for general across-the-board price changes, or for uploading products into new or alternate shopping cart software, requirements for a complete file import tend to be sporadic. More common is the need to perform immediate or delayed partial updates of a small number of products, often a single product at a time. For example, to reduce the price of products the manufacturer has discontinued. When import files are used by conventional methods, such partial updates are unworkable because a subsequent file import would overwrite the changes made during the partial update unless identical changes had also been recorded in the import file. As will be illustrated in the flowchart of FIG. 14, both immediate and delayed partial updates maintain data validity when performed by the present invention.

Initially in the process of FIG. 14, a value from a master identifier data field 410 (FIG. 7) may be received by the input device in step 5020. Next, at step 5021, the product management program 101 (FIG. 1) may first retrieve the master data record 310 from the master records table 400 of the web products database 103, then retrieve all configuration records 312, 314, 316, associated with the master data record 310. Next, at step 5022, the product management program 101 may receive one or more changes through the input device 121 (FIG. 4).

Following step 5022 is a decision block 5023 at which it is determined whether software is available to automatically calculate product and option prices in step 5024. If no pricing software is available, prices may be received through the input device 121 (FIG. 1) in step 5025. Next, at step 5026, the product management program 101 may store the updated master data record 310 and configuration records 312, 314, 316, in the web products database 103 (FIG. 4). Using the retrieved data, the data set generating program 102, at step 5027, may then regenerate the respective data set in the file format and data structure required for a desired shopping cart software 125 program.

Following step 5027 is a decision block 5028 at which it is determined whether the seller intends to perform a partial update now, or delay the update until the next file import. Because the changes have already been recorded in the web products database 103, and the data set has already been regenerated to reflect the changes, a general file import will overwrite the partial update, but it will overwrite it with up-to-date prices and properties.

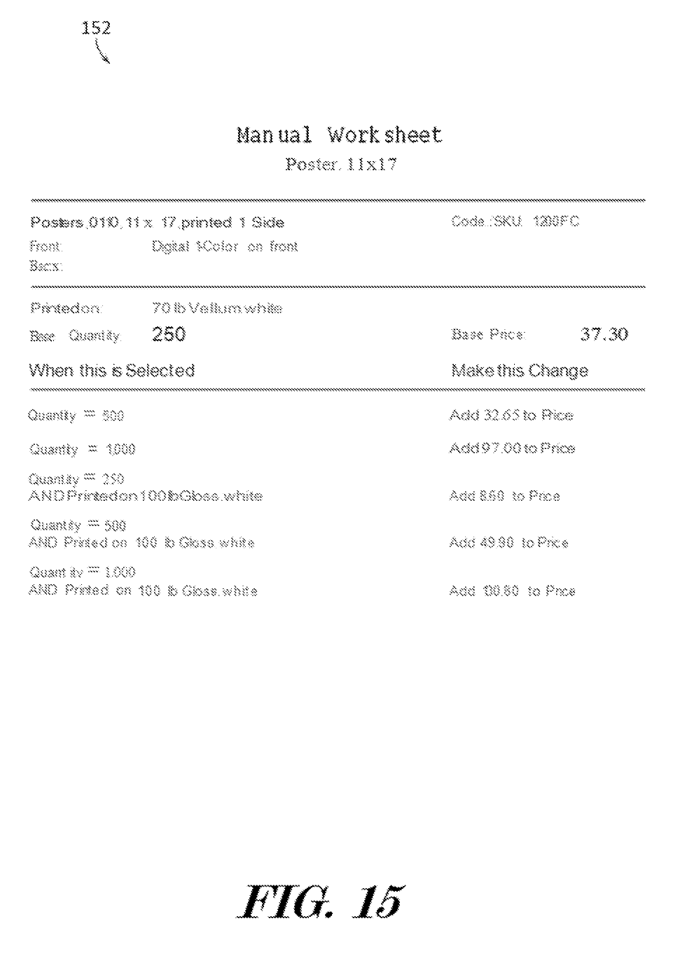

If the seller prefers to perform a partial update now, in step 5029 the product management program 102, using the totality of data from the master data record 310 and its associated configurations that were updated in step 5026, may then create a manual worksheet that it may then send to the printer 123 (FIGS. 1 and 4) and/or display on a display device 122 (FIG. 4). Prices and other properties of the product depicted in the exemplary manual worksheet 152 illustrated in FIG. 15 may be generated from the newly updated data set for this product. Immediate updates, using the data contained in the manual worksheet 152, can thus be performed directly in the shopping cart software without fear of having those updates nullified during a subsequent file import. Conversely, if a partial update is delayed, prices and properties of the respective product will automatically be updated during the next file import.

Finally, at the decision block 5030, it is determined whether the seller wants to enter another web product into the web products database 103 (FIG. 1). If yes, the process 5019 may continue to step 5020. If no, the process 5019 may continue to step 5031 and the process may end.

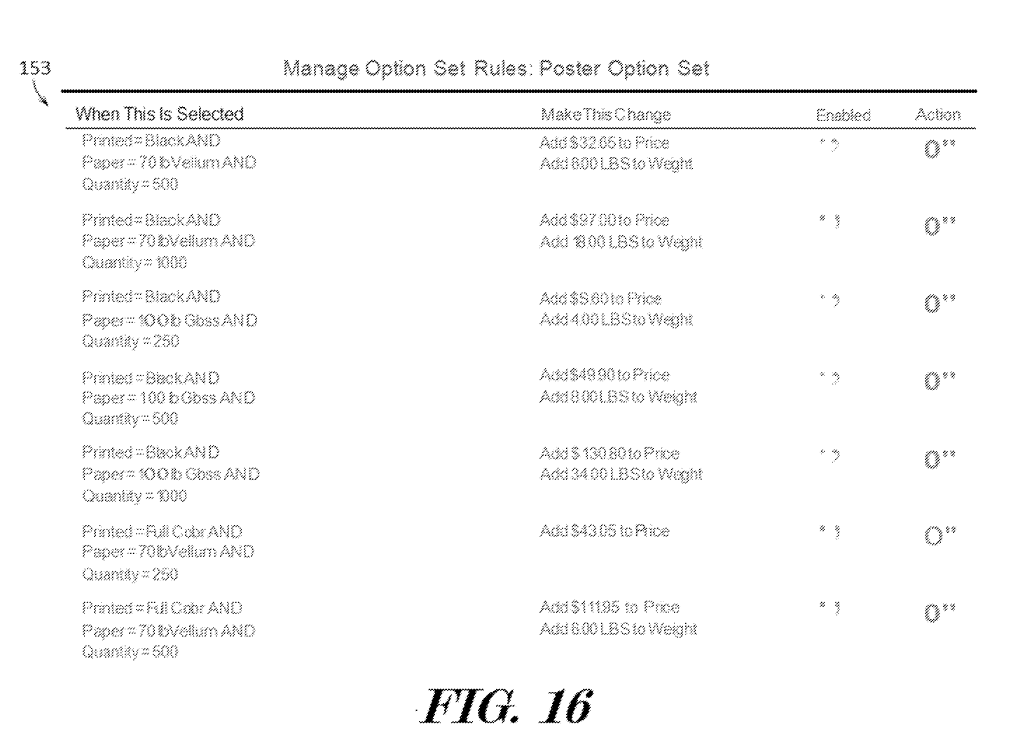

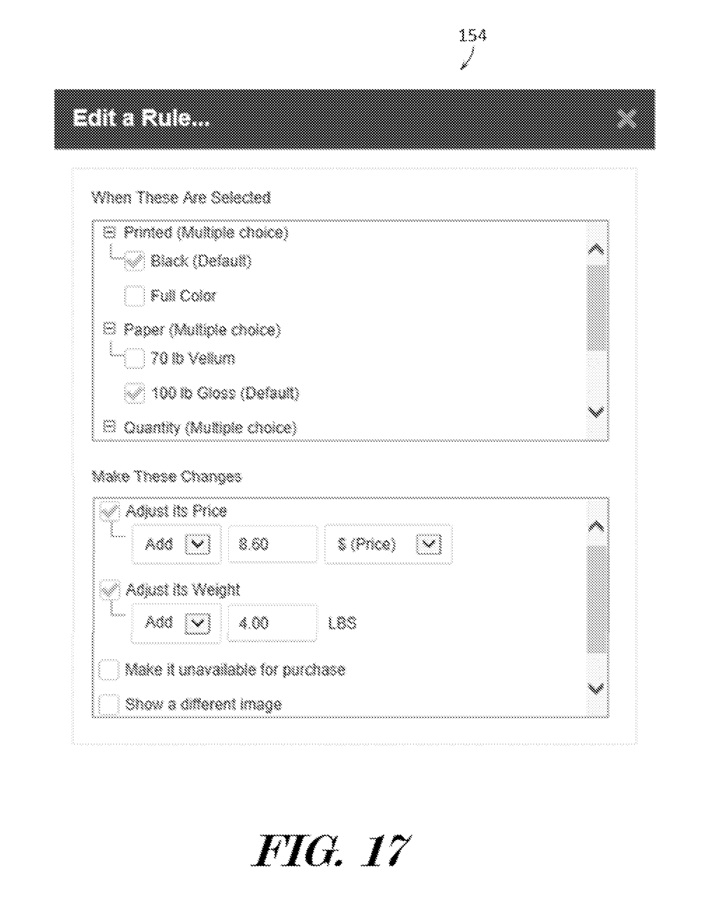

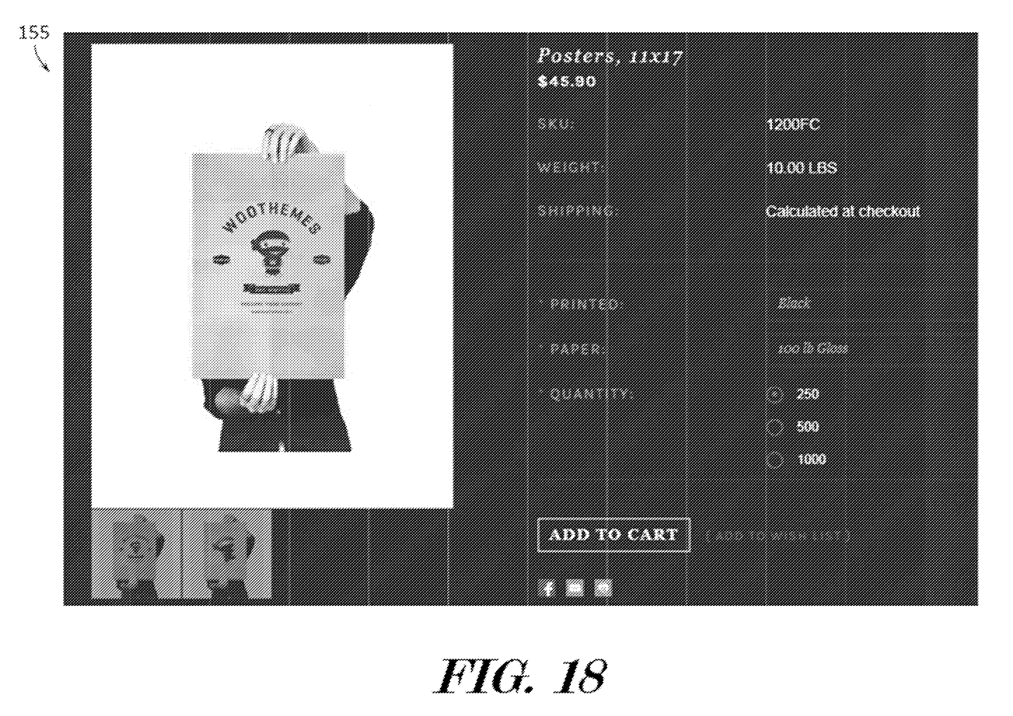

FIG. 15 illustrates an example of a manual worksheet 152 designed to assist entering a poster into a shopping web site powered by the shopping cart software 125 of the exemplary shopping website “BigCommerce.” The example entry forms 153, 154, are illustrated in FIGS. 16 and 17, and the resulting example shopping web page 155 is illustrated in FIG. 18. As will be noted, the poster is priced at $37.30 when offered in its base configuration of “quantity 250, printed on 70 lb Vellum paper.” If the customer decides to upgrade to “100 lb Gloss paper,” the listing price is increased by $8.60 to a total of $45.90.

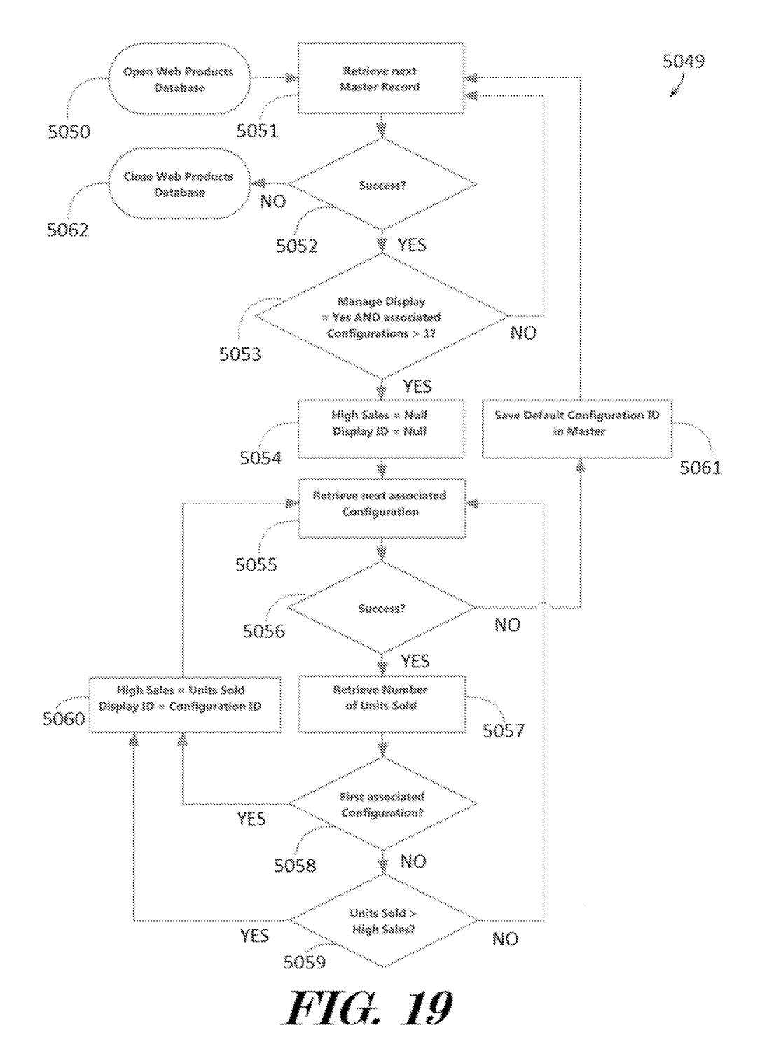

FIG. 19 depicts a process for managing the display of the most desired configuration of a complex product on a seller's shopping website (“the process”) 5049 according to various embodiments described herein. In some embodiments, the process 5049 may be carried out by the product management program 101 (FIG. 4) for the purpose of displaying the best selling configuration of a complex product as the default configuration on the seller's shopping web site. The process of FIG. 19 may begin with step 5050 in which the web products database 103 (FIG. 4) may be accessed by the product management program 101 (FIG. 4) to access, such as sequentially, one or more master data records 310. Next, at step 5051, the program 101 may attempt to retrieve a first master record 310. If the attempt fails at step 5052 (which typically indicates that the end of the file has been reached), the process 5049 may end with the closure of the web products database at step 5062.

Following step 5052 is a decision block 5053 at which it is determined whether the product management program 101 is allowed to exchange the default configuration when it is found that another configuration has sold in greater volume. If the value stored in the manage display data field 414 (FIG. 7) is “no,” the program 101 may cycles back to step 5051 to retrieve the next master record 310. If “yes” and there exists more than one associated configuration of the configurable product of the master record 310, two variables (“High Sales” and “Display ID”) may be initialized to “null” at step 5054. It should be noted that a minimum of two associated configurations are necessary to enable a choice.

Next, at step 5055, the program 101 may attempt to retrieve from the web products data base 103 (FIG. 4) illustrated with configuration records table 500 (FIG. 8) a configuration associated with the master record 310 being managed. If the attempt fails at step 5056, the process 5049 may retrieve the value found in the variable “Display ID” and stores it in the default configuration identifier data field 412 (FIG. 7) before cycling back to retrieve the next record in step 5051. A failed attempt may indicates either that the master record 310 is for a simple product having no associated configurations, or that all associated configuration records 312, 314, 316 (FIG. 6), have already been found.

Next, at step 5057, the program 101 may retrieve the cumulative number of units sold of this configuration from the values in data objects 551 and 552 (FIG. 8). In some embodiments, other time periods for measuring sales may be used. For example, where purchases are not subject to seasonal fluctuations, time periods could simply be based on calendar quarters.

Following step 5057 is a decision block 5058 at which it is determined whether the configuration record 312, 314, 316 (FIG. 6) is the first associated configuration record retrieved for the master data record 310. If it is found that the configuration record 312, 314, 316 is the first associated configuration record, step 5060 may be performed, replacing the value stored in the variable “High Sales” by the number of units sold, and replacing the value stored in the variable “Display ID” by the value stored in configuration identifier data object 510 (FIG. 8). For example, using the exemplary entries in FIGS. 7 and 8, “Display ID” would be “2261” (the configuration identifier 510 of the first associated configuration record 312, 314, 316). The program 101 may then attempt to retrieve the next associated configuration record 312, 314, 316, at step 5055. If it is found at step 5058 that the configuration record 312, 314, 316, is not the first associated configuration record, then the process 5049 may continue to decision block 5059 following block 5058.

At decision block 5059 it is determined whether the number of units sold is greater than the value contained in the variable “High Sales.” If it is found that the number of units sold is greater, the program 101 may carry out the instructions described above for step 5060, followed by the instructions for step 5055. If the number of units sold is not greater, the values in the variables “High Sales” and “Display ID” remain unchanged, and the program 101 may attempt to retrieve the next associated configuration record 312, 314, 316, at step 5055. The process 5049 may continue until the desired number of master data records 310 have been accessed.

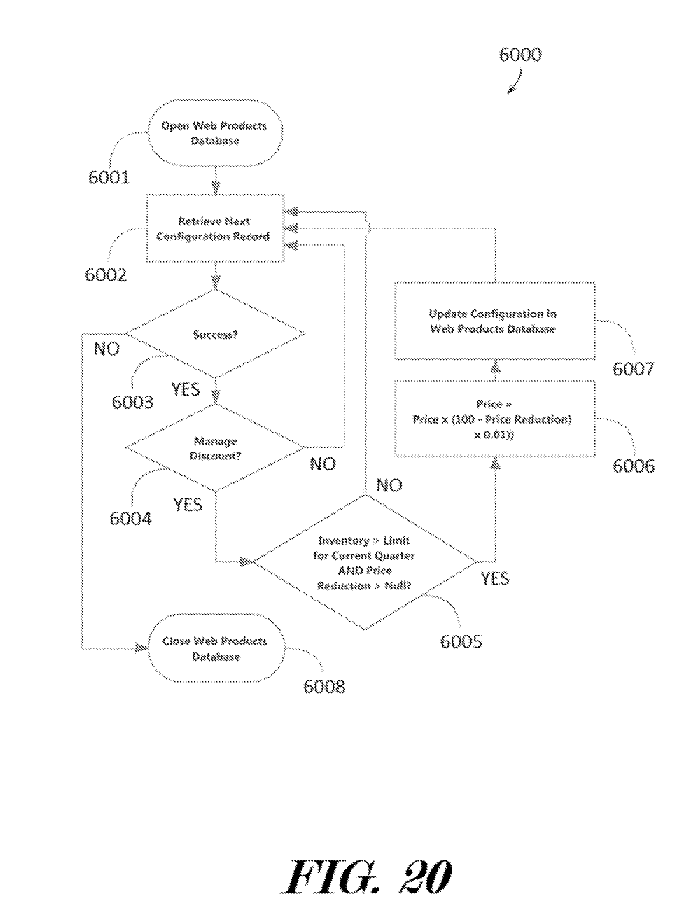

FIG. 20 illustrates a process for managing the listing price of an overstocked configuration of a complex product on the seller's shopping website (“the process”) 6000 according to various embodiments described herein. In some embodiments, the process 6000 may be completed to automatically reduce the listing price of a product when the quantity on hand exceeds limits set by the seller. The process 6000 may begin with step 6001 in which the web products database 103 (FIG. 4) may be accessed to enable the product management program 101 (FIG. 4) to sequentially access one or more configuration records 312, 314, 316, (FIG. 6). Next, at step 6002, the program 101 attempts to retrieve the first configuration record 312, 314, 316. If the attempt fails at step 6003 (which typically indicates that the end of the file has been reached), the process 6000 may end with the closure of the web products database at step 6008.

Following step 6003 is a decision block 6004 at which it is determined whether the product management program 101 is permitted to reduce the listing price for this configuration record 312, 314, 316, for a configuration of a configurable product. If the value stored in the manage discount data object 560 (FIG. 8) is “no,” the program may cycle back to step 6002 to retrieve the next configuration record 312, 314, 316. If “yes,” then a decision the process 6000 may continue to block 6005.

At block 6005, the result may be determined by two conditions: First, whether the number of units currently on hand (the value in inventory data object 550 FIG. 8), exceeds the limit set by the seller for inventory limit data objects 561-564 (FIG. 8). Second, whether the value of the price reduction in data object 565 (FIG. 8) is greater than null. Preferably, only if both conditions are met will the listing price be reduced in step 6006 and the new price recorded in step 6007. Otherwise the price remains unchanged, and the program cycles back to step 6002 to retrieve the next configuration record 312, 314, 316, (FIG. 6).

For example, the inventory data object 550 (FIG. 8) shows an illustrative value of “23” units. The inventory limit for Q1 561 (FIG. 8) is “20.” If the process 6000 were to be carried out in the first calendar quarter, the product management program 101 would reduce the listing price by “25%” for “14” days. It is of course understood that, depending on the nature of the product, inventory levels could be tracked at different intervals.

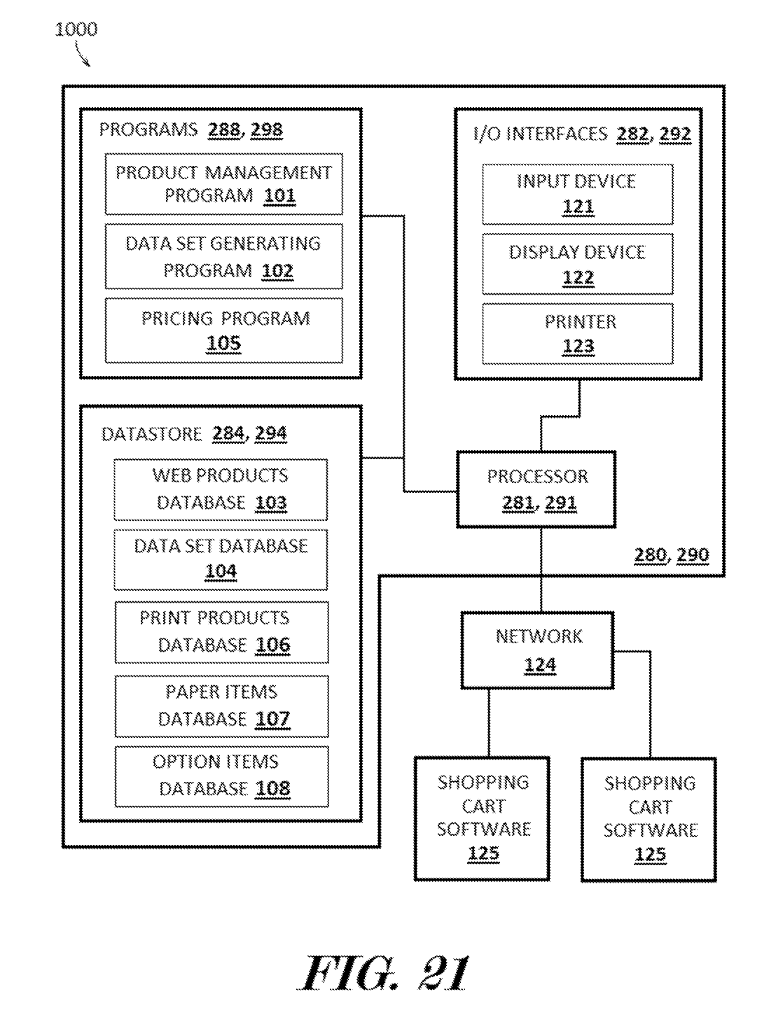

An alternative embodiment of the present invention will now be described with reference to FIGS. 21-32. As described below, the system 100 and methods may be used by a print service provider and includes an integrated pricing program. In other embodiments, the system 100 and methods may be used by any other service or goods provider. The following is exemplary, and it is contemplated that the functionality described herein and claimed below may be adapted for use by providers of services other than printing, with any suitable ecommerce site. It should be noted that names of data bases such a web products data base 103 (FIG. 21), a data set data base 104 (FIG. 21), a print products database 106 (FIG. 21), and/or a paper items data base 107 (FIG. 21) may be changed to reflect the type of products to be stored. In this example, “print” and “paper” are optional descriptive terms which may be changed or omitted.

Virtually all products sold by a print shop are assemblies of inventoried components invoiced by quantity (for example printing plates and paper) and services charged by the hour (such as putting ink on paper). To offer such assemblies on a shopping web site requires that the seller predefine and price common assemblies, then list such assemblies as base products with options. At a minimum, the seller has to list prices for different quantities. Other options typically include a variety of paper items on which the product can be printed, and finishing options such as folding.

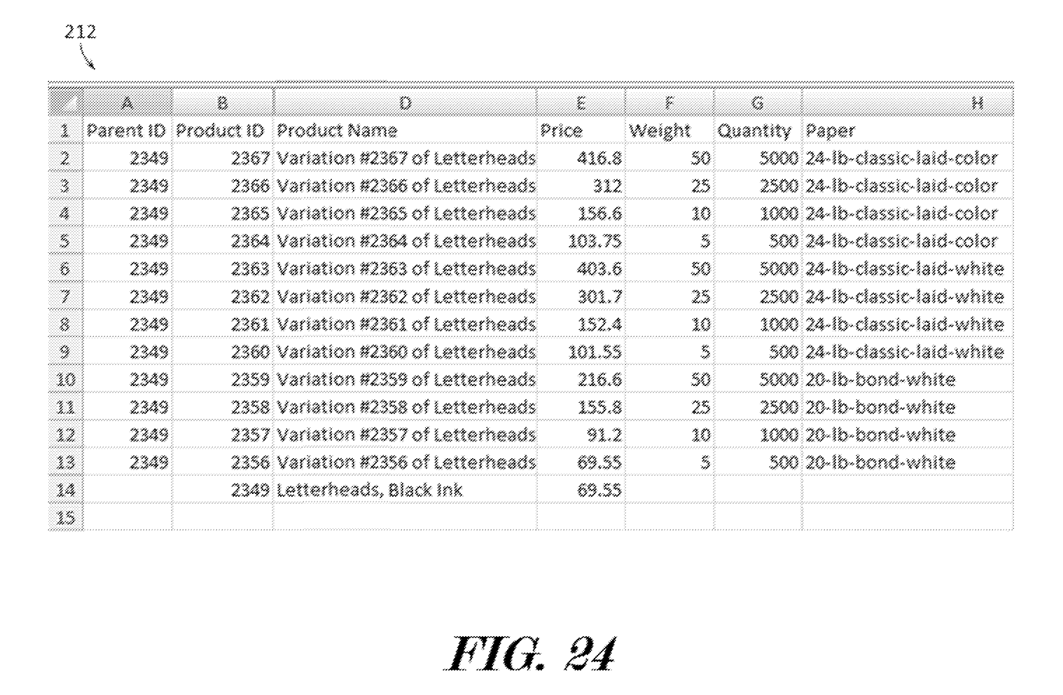

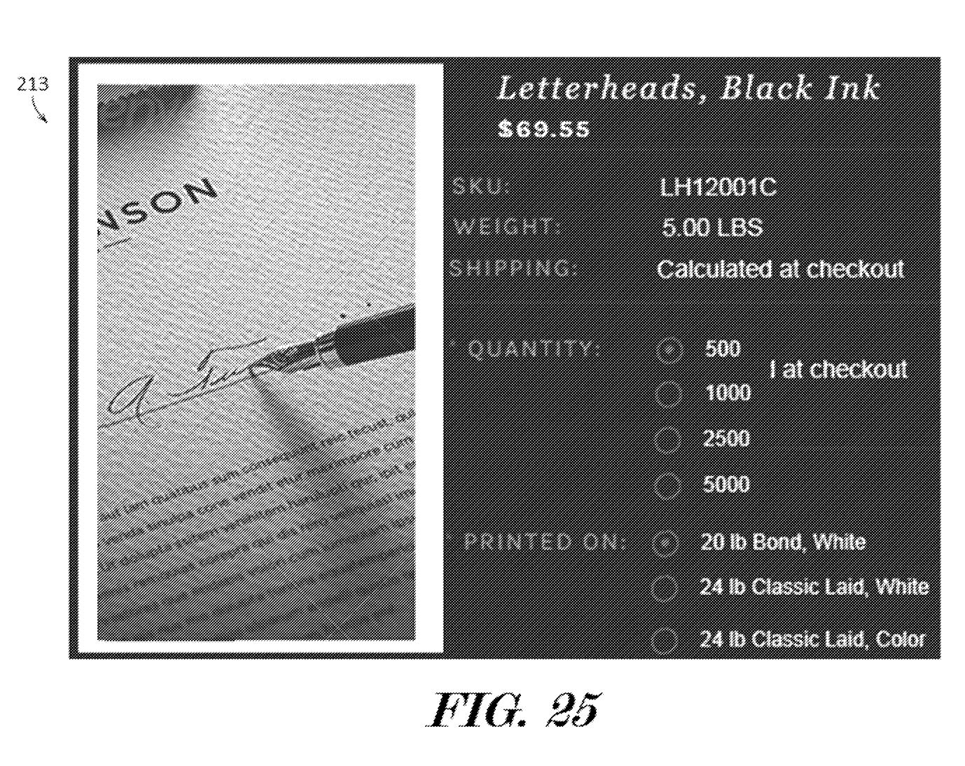

FIG. 25 illustrates an example of a letterhead available in four quantities on three types of paper, listed on a BigCommerce-powered demo web store ecommerce site. Without benefit of an integrated pricing program, the seller would have to first calculate the price of the letterhead in its base configuration (Product ID 2356, (FIG. 24)), then calculate the price for each of eleven optional configurations (Product IDs 2357-2367):

Calculate the price for four quantities, when printed on 20 lb Bond, White (500=$69.55; 1000=$91.20; 2500=155.80; 5000=$216.60).

Calculate the price for four quantities, when printed on 24 lb Classic Laid, White (500=$101.55; 1000=$152.40; 2500=301.70; 5000=$403.60).

Calculate the price for four quantities, when printed on 24 lb Classic Laid, Color (500=$103.75; 1000=$156.60; 2500=312.00; 5000=$416.80).

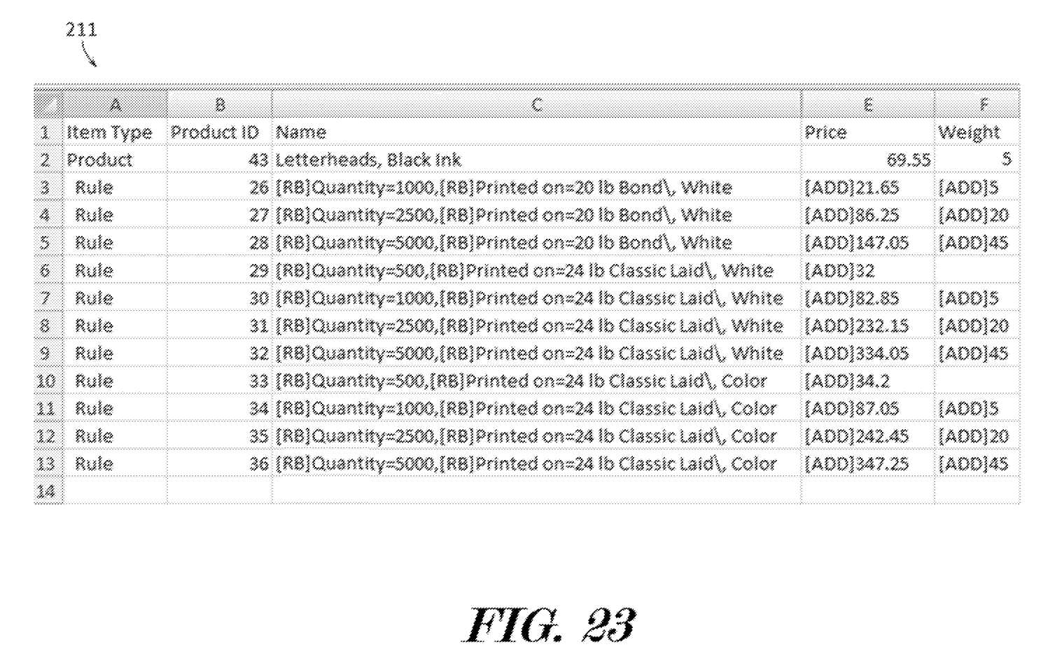

For a BigCommerce-powered shopping web site, the seller would additionally have to perform eleven calculations depicted by Product IDs 26-36 (FIG. 23) before the letterhead and associated option rules could be entered into the seller's shopping cart software:

Calculate the difference in price between 500 letterheads printed on 20 lb Bond, White and three remaining quantities on 20 lb Bond, White.

Calculate the difference in price between 500 letterheads printed on 20 lb Bond, White and four quantities printed on 24 lb Classic Laid, White.

Calculate the difference in price between 500 letterheads printed on 20 lb Bond, White and four quantities printed on 24 lb Classic Laid, Color.

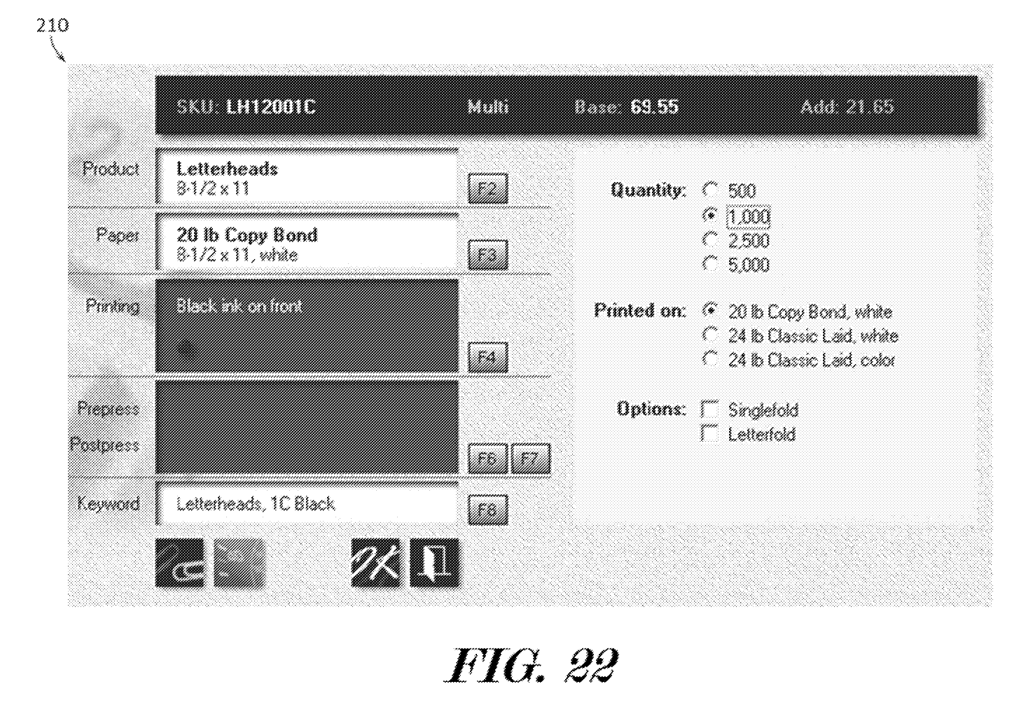

FIG. 22 illustrates an example of a data entry window 210 from a print shop web product management program which may be incorporated into the system 1000 and methods described herein. A pricing program 105 (FIG. 21) which may use any price-calculating algorithm may also be used by a pricing program incorporated into the system 1000 and methods described herein.

As shown in FIG. 21, in some embodiments, the system 1000 may comprise a print shop pricing program 105, product management program 101, and data set generating program 102, thus enabling the system 1000 to generate vendor-specific data sets for a plurality of different shopping cart software 125 programs.

For example, FIG. 23 depicts an Excel file 211 structured for importing products into BigCommerce software. FIG. 24 depicts an Excel file 212 structured for importing products into WooCommerce software. The most striking difference between the two is that BigCommerce software requires prices and weights to be entered as differential values between the base and optional configurations, whereas WooCommerce software requires entry of the total amount. An example of a resulting web shopping page 213 using data from Excel file 211 structured for importing products into BigCommerce software (FIG. 23) or Excel file 212 structured for importing products into WooCommerce software (FIG. 24) is illustrated in FIG. 25.

In the exemplary data, the base configuration consists of 500 letterheads, black ink on 20 lb white Bond, priced at $69.55. The first optional configuration increases the quantity to 1,000 with all other properties except for weight remaining the same.

The “Rules” depicted in FIG. 23 are vendor-specific to BigCommerce. Line 2 in the illustration shows the base configuration of the complex product letterhead printed on 20 lb white Bond. The value of $69.55 in column “E” represents the base price for a quantity of 500. Line 3 (Product ID 26) instructs the shopping cart software to ADD $21.65 for a total of $91.20 when the quantity is increased to 1,000.

The “Variations” correspond to configurations of the complex product letterhead 2349 depicted in FIG. 24 are vendor-specific to WooCommerce. Here line 12 (Product ID 2357) instructs the shopping cart software to CHARGE $91.20 when the quantity is increased to 1,000.

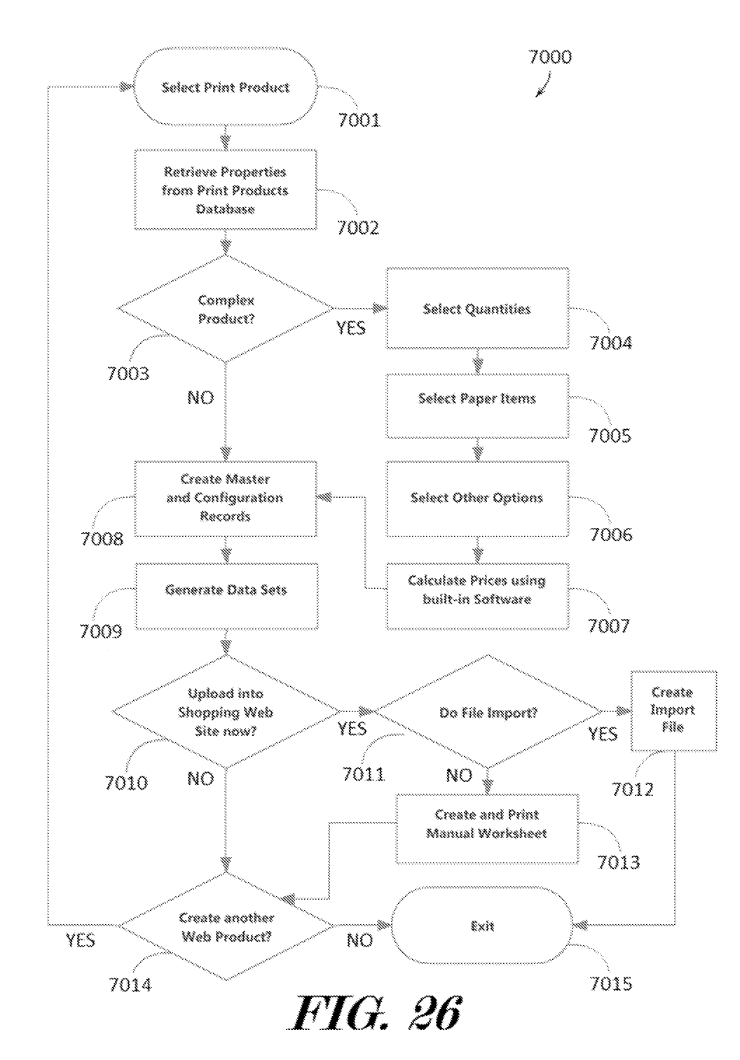

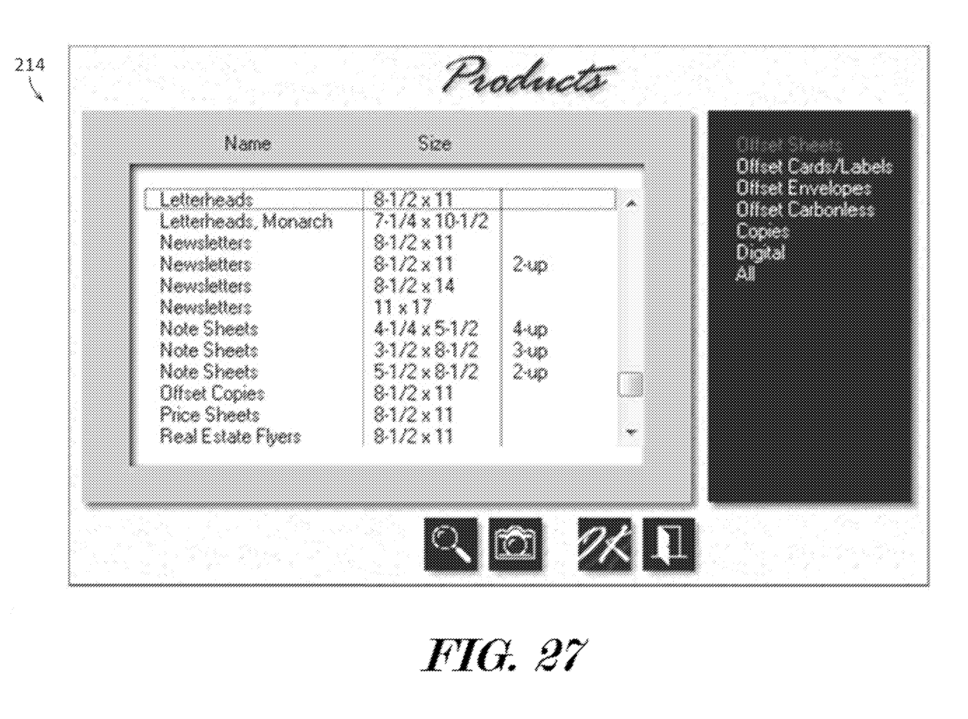

FIG. 26 illustrates an example of a process for entering a new product into shopping cart software (“the process”) 7000 designed for a print shop according to various embodiments described herein. In some embodiments, the process 7000 may be carried out by the product management program 101 (FIG. 21) with user 110 input received through input device 121 (FIG. 21) and with an optional integrated, industry-specific pricing program 105 (FIG. 21) such as for a print shop. Initially, at step 7001 a print product may be selected via the input from an input device 121 from a collection of predefined products in the print products database 106 (FIG. 21). In the example screen capture 214 of an exemplary pick list for selecting the print product depicted in FIG. 27 from a print products database 106, the product is a “letterhead, size 8.5×11.” Next, at step 7002, properties and specifications of the selected product may be retrieved by the product management program 101 from the print products database 106.

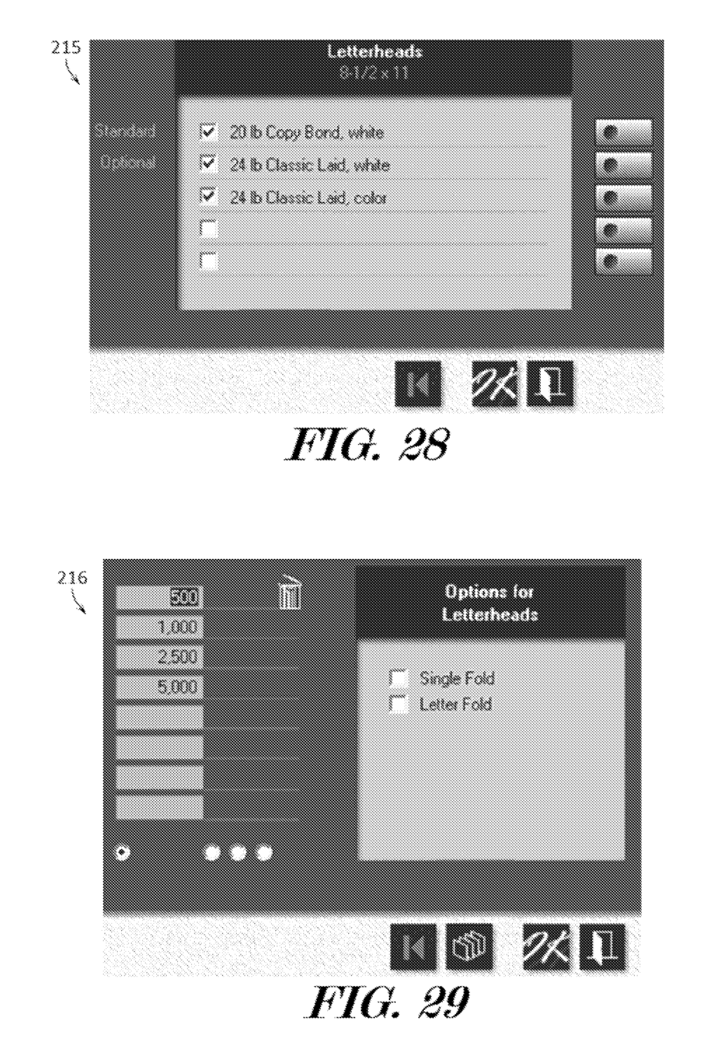

Following step 7002 is decision block 7003 at which it is determined whether the product is a simple product with no options or a complex product with options. If complex, the product management program first executes steps 7004-7006 to receive quantity, paper, and other options from input device 121, then adds this information to the product properties and specifications retrieved at step 7002 and relays the consolidated data to the pricing program 105. In a print shop, options typically available for complex products are quantity, type of paper, and finishing operations, as illustrated in the screen capture of an exemplary entry screen 210 in FIG. 22, the screen capture of an exemplary entry screen 215 in FIG. 28, and the screen capture of an exemplary entry screen 216 in FIG. 29.

Prices of complex products, such as complex print products, may be derived from an assortment of values that remain constant regardless of the quantity to be printed (for example printing plates), and variable values that change with the length of the press run. Constant values can be stored as properties of the product in a data base such as the print products database 106 (FIG. 21). Variable values often cannot. The amount of time it takes to print a product is a variable value contingent on the quantity to be printed. Until that quantity is known, it is impossible to calculate a price. Therefore, the price of a complex print product may also be considered a variable value that may not be stored in the print products database 106 (FIG. 21), which may prevent its retrieval at step 7002. Because of this limitation, complex print product values are typically stored as a set of preset, fixed parameters that will enable print pricing software 105 to calculate prices once the quantity and other variable values are known. Examples of such options of complex printing products are the dimensions of the product and the press sheet, the number of ink colors, and the press to be used for production.

At step 7007, using the combination of properties and specifications retrieved at step 7002, and quantity, paper, and other options received at steps 7004-7006, the pricing program 105 software may first retrieve prices of the selected paper items and other options from the respective databases 107 and 108 (FIG. 17), then calculate the listing price for each configuration of the complex product and may then pass the results back to the product management program 101.

Simple print products do not need to be managed by the integrated pricing software 105. By definition, such products have no options. Their single, fixed price has been stored in, and can be retrieved from, the print products database 106. Simple products are rare in a print shop environment. They are generally limited to greeting cards and promotional items, if offered at all.

Next, at step 7008, the product management program 101 may create the master data record 310 (FIG. 6) and one or more configuration records 312, 314, 316 (FIG. 6) and then store the records in the web products database 103 (FIG. 21).

Next, at step 7009, the data set generating program 102 (FIG. 21) may first retrieve a master data record 310 (FIG. 6) such as from the master records table 400 (FIG. 7) of the web products database 103, then retrieves all configuration records 312, 314, 316 (FIG. 6) associated with this master data record 310. Using the retrieved data, the data set generating program 102 may then generate a data set in the file format and data structure native to a shopping cart software 125 program, comprising data from the master record 310 and data from all its associated configurations 312, 314, 316.

Following step 7009 is decision block 7010 at which it is determined whether the seller intends to upload the data of the product into the seller's shopping web site software 125 (FIG. 21) now or at a future date. If the seller decides to upload now, step 7010 is followed by another decision block 7011 at which it is determined whether the upload is to be performed as a partial update for this product only, or as part of a file import comprising data on two or more products. If a file import is selected, the data set generating program 102, at step 7012, using the data set created in step 7009, produces an import file suitable for the seller's shopping cart software 125 with data in the file format and data structure native to a shopping cart software 125 program. Advantageously, in certain embodiments, the shopping cart software 125 (FIG. 21) may offer an API to the resources and events at the seller's shopping web site. This enables the data set generating program 102 to update the seller's shopping web site directly via a network connection 124 (FIG. 21) between the processor 281, 291 (FIG. 21), and the shopping cart software 125, thus eliminating the need for an import file.

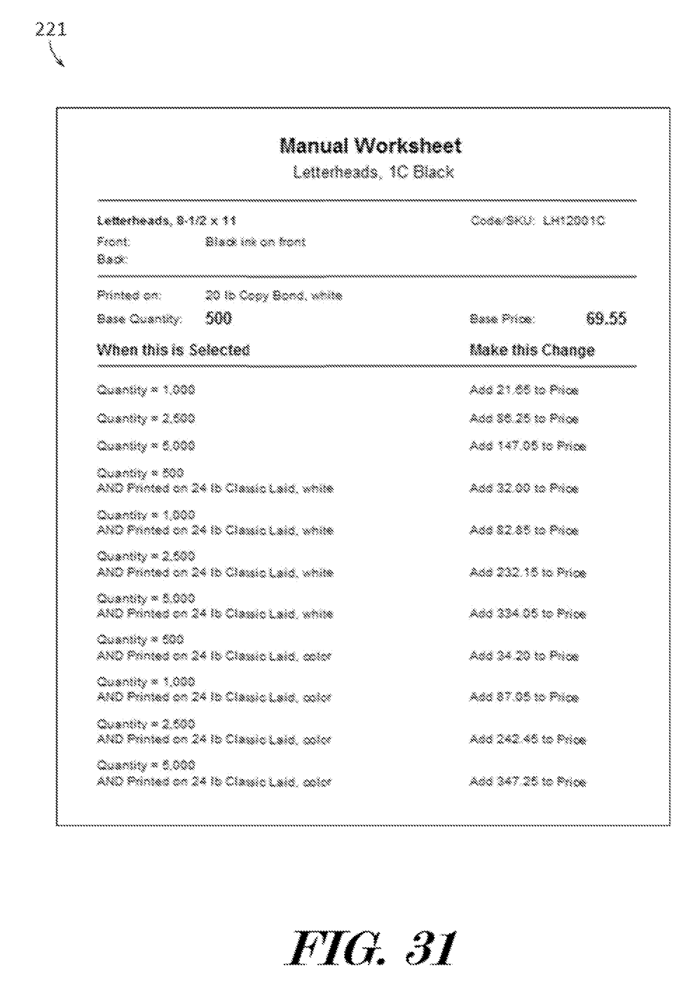

If at step 7011 the seller may select to perform a partial update for this product only, in step 7013 the product management program 101, using data from the master data record 310 (FIG. 6) and its associated configuration records 312, 314, 316 (FIG. 6) that were created in step 7008, outputs the data such as by producing a manual worksheet in step 7013 that it may then send to the printer 123 (FIG. 21) or display device 122 (FIG. 21). Prices and other properties of the product depicted in the exemplary manual worksheet 221 illustrated in FIG. 31 are generated from the newly created data set for this product.

Following step 7013 (and step 7010 if the seller decides to not upload the product now) is a decision block 7014 at which it is determined whether the seller desires to enter another web product into the web products database 103 (FIG. 21). If the seller desires to enter another web product into the web products database 103, the method 7000 may proceed to step 7001. If not, the method 7000 may end 7015.

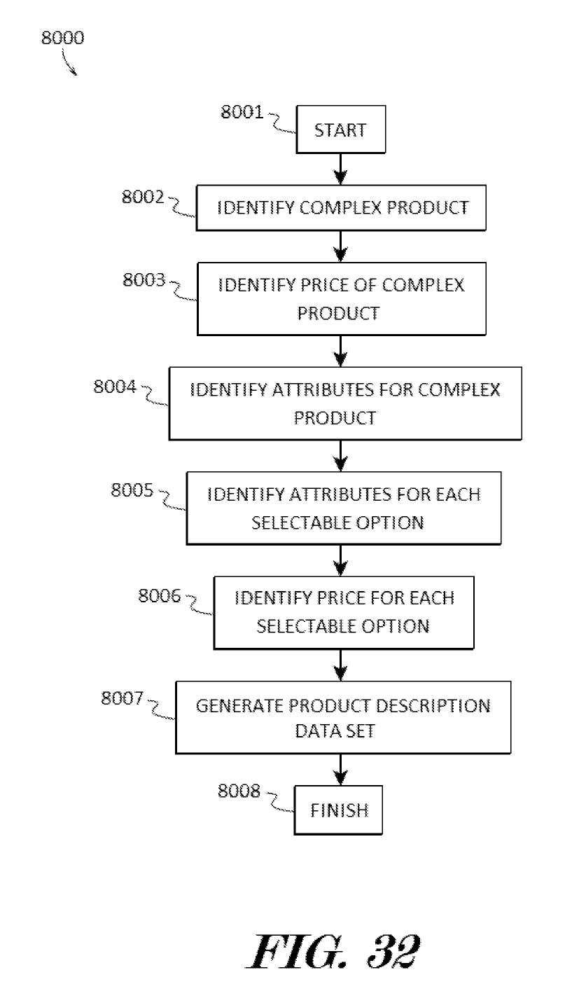

FIG. 32 shows a flow chart that illustrates an example of a computer implemented method for generating a product description data set for use on a shopping website (“the method”) 8000 which may be used to manage prices and descriptions of products on the shopping website according to various embodiments described herein. In some embodiments, the method 8000 may be carried out by the product management program 101 (FIG. 21) with user 110 (FIG. 1) input received through input device 121 (FIG. 21) and with an optional integrated, industry-specific pricing program 105 (FIG. 21).

In some embodiments, the method 8000 may start 8001 with identifying a complex product in step 8002. The complex product may have one or more selectable options which may be selected to form a product configuration for the complex product. Optionally, the complex product may be identified from a web products data base 103 (FIG. 21) by user input received through an input device 121 (FIG. 21), by a product management program 101 (FIG. 21) as it cycles through a web products data base 103, and/or through any other method of identifying.

In step 8003 the price of the complex product may be identified. In some embodiments, the price of the complex product may be retrieved and identified from a web products data base 103 (FIG. 21), a data set data base 104 (FIG. 21), a print products database 106 (FIG. 21), and/or a paper items data base 107 (FIG. 21). In further embodiments, the price of the complex product may be identified by an optional pricing program 105 (FIG. 21) which may calculate the price of the complex product using data retrieved from a web products data base 103, a data set data base 104, a print products database 106, and/or a paper items data base 107.

In step 8004, attributes for the complex product may be identified. These attributes may comprise any data that is specific to the complex product. In some embodiments, the attributes of the complex product may be retrieved and identified from a web products data base 103 (FIG. 21), a data set data base 104 (FIG. 21), a print products database 106 (FIG. 21), and/or a paper items data base 107 (FIG. 21). In further embodiments, the attributes of the complex product may be identified by a product management program 101 (FIG. 21) data retrieved from one or more data fields such as found in a web products data base 103, a data set data base 104, a print products database 106, and/or a paper items data base 107.

In step 8005, attributes for each selectable option of the complex product may be identified. These attributes may comprise any data that is specific to each selectable option of the complex product. In some embodiments, the attributes of the each selectable option of the complex product may be retrieved and identified from a web products data base 103 (FIG. 21), a data set data base 104 (FIG. 21), a print products database 106 (FIG. 21), and/or a paper items data base 107 (FIG. 21). In further embodiments, the attributes of each selectable option of the complex product may be identified by a product management program 101 (FIG. 21) data retrieved from one or more data fields such as found in a web products data base 103, a data set data base 104, a print products database 106, and/or a paper items data base 107.

In step 8006 a price for each selectable option of the complex product may be identified. In some embodiments, the price of each selectable option of the complex product may be retrieved and identified from a web products data base 103 (FIG. 21), a data set data base 104 (FIG. 21), a print products database 106 (FIG. 21), and/or a paper items data base 107 (FIG. 21). In further embodiments, the price of each selectable option of the complex product may be identified by an optional pricing program 105 (FIG. 21) which may calculate the price of the complex product using data retrieved from a web products data base 103, a data set data base 104, a print products database 106, and/or a paper items data base 107.

Next, in step 8007 a product description data set may be generated by a data set generating program 102 using the data retrieved and identified in steps 8002 through 8005. In alternative embodiments, steps 8002 through 8005 may be performed in any order prior to step 8007. In some embodiments, the product description data set may comprise a price and one or more attributes for each product configuration of the complex product. In further embodiments, the price of each product configuration of the complex product may be based on the price of the complex product and the price of each selected option forming the product configuration for the complex product. In still further embodiments, attributes of each product configuration of the complex product may be based on the attributes of the complex product and on the attributes of each selected option forming the product configuration of the complex product. It is important to note that in some embodiments, a complex product may have a base configuration in which no additional options are selected. For the purposes of this disclosure, a base configuration may be a product configuration of the complex product with the selectable option being no additional selectable options. Once a product description data set has been generated, in some embodiments, the method 8000 may finish 8008.

In some embodiments, the product description data set may comprise a set of data fields universal to each complex product, with each complex product and configuration of each complex product comprising the same set of data fields as the example data fields 510-516, 550-556, 560-566 shown in FIG. 8.

In some embodiments, the product description data set may comprise a set of data fields universal to each product configuration of a complex product, with each configuration of each complex product comprising the same set of data fields as the example data fields 510-516, 550-556, 560-566 shown in FIG. 8.

In some embodiments, the product description data set may comprise a set of data fields universal to each complex product and to each product configuration of a complex product, with each complex product and each configuration of each complex product comprising the same set of data fields as the example data fields 510-516, 550-556, 560-566 shown in FIG. 8.

In further embodiments, the method 8000 may comprise the step of generating a manual worksheet comprising data on a configuration of a complex product when a change is made to data in a field of the configuration of a complex product.

In further embodiments, the method 8000 may comprise the step of generating an import file comprising one or more of the data fields universal to each complex product. In still further embodiments, the method 8000 may comprise the step of generating an import file comprising one or more of the data fields universal to each product configuration of a complex product. Data from each data field may be formatted, such as separated by commas, colons, and the like, to match the required data format of a desired shopping cart software 125 program (FIG. 21).

In some embodiments, the product description data set may comprise a master data record 310 (FIG. 6) which may include a price and one or more attributes for each product configuration of the complex product. In further embodiments, the product description data set may comprise a configuration record 312, 314, 316 (FIG. 6) for each configuration of a complex product which includes a price and one or more attributes for each product configuration of the complex product.

In further embodiments, the method 8000 may comprise the step of generating a first import file comprising one or more of the data fields universal to each complex product and generating a second import file comprising one or more of the data fields universal to each complex product. In further embodiments, one or more of the data fields universal to each complex product of the first import file may be different than one or more of the data fields universal to each complex product in the second import file. In still further embodiments, data in one or more of the data fields universal to each complex product of the first import file may be stored in a different format than the format of the data in one or more of the data fields universal to each complex product in the second import file.

In further embodiments, the method 8000 may comprise the step of identifying the number of each configuration of a complex product in inventory. This inventory data may be retrieved from a data base 103, 104, 106, 107, and/or 108 (FIG. 21), or may be received as input through an input device 121 (FIG. 21). In still further embodiments, the method 8000 may comprise the step of identifying an inventory limit for a configuration of a complex product and a price reduction amount to be applied to the price of the configuration of a complex product when the inventory limit is exceeded. This inventory limit data may be retrieved from a data base 103, 104, 106, 107, and/or 108 (FIG. 21), or may be received as input through an input device 121 (FIG. 21). In still further embodiments, the price of each product configuration of a complex product is based on the price of the complex product, the price of each selected option forming the product configuration for the complex product, and the price reduction amount when the inventory of a configuration of a complex product exceeds the inventory limit for that complex product. In further embodiments, the product description data set comprises a master data record which includes a price may be based on the price of the complex product, the price of each selected option forming the product configuration for the complex product, and the price reduction amount when the inventory of a configuration of a complex product exceeds the inventory limit for that complex product and one or more attributes for each product configuration of the complex product. In further embodiments, the product description data set may comprise a configuration record for each configuration of a complex product which includes a price is based on the price of the complex product, the price of each selected option forming the product configuration for the complex product, and the price reduction amount when the inventory of a configuration of a complex product exceeds the inventory limit for that complex product and one or more attributes for each product configuration of the complex product. In still further embodiments, the method 8000 may further comprise the step of using this product description data set to generate an import file comprising one or more of the data fields universal to each complex product and each configuration of each complex product using data. In still further embodiments, the method 8000 may further comprise the step of using this product description data set to generate a first import file comprising one or more of the data fields universal to each complex product and to generate a second import file comprising one or more of the data fields universal to each complex product. In still further embodiments, one or more of the data fields universal to each complex product of the first import file may be different than one or more of the data fields universal to each complex product in the second import file. In still further embodiments, data in one or more of the data fields universal to each complex product of the first import file is stored in a different format than the format of the data in one or more of the data fields universal to each complex product in the second import file.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or wifi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and wifi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for generating a product description data set for use on a shopping website, the method comprising:
identifying a complex product with one or more selectable options which are selected to form a product configuration for the complex product;
identifying the price of the complex product;
identifying one or more attributes for the complex product;
identifying one or more attributes for each selectable option of the complex product;
identifying a price for each selectable option of the complex product; and
generating a product description data set comprising a price and one or more attributes for each product configuration of the complex product, wherein the price of each product configuration of the complex product is based on the price of the complex product and the price of each selected option forming the product configuration for the complex product, and wherein the attributes of each product configuration of the complex product are based on the attributes of the complex product and on the attributes of each selected option forming the product configuration of the complex product.

2. The method of claim 1, wherein the product description data set comprises a set of data fields universal to each complex product.

3. The method of claim 2, wherein the product description data set comprises a set of data fields universal to each product configuration of a complex product.

4. The method of claim 2, further comprising the step of generating an import file comprising one or more of the data fields universal to each complex product.

5. The method of claim 3, further comprising the step of generating an import file comprising one or more of the data fields universal to each product configuration of a complex product.

6. The method of claim 1, wherein the product description data set comprises a master data record which includes a price and one or more attributes for each product configuration of the complex product.

7. The method of claim 1, wherein the product description data set comprises a configuration record for each configuration of a complex product which includes a price and one or more attributes for each product configuration of the complex product.

8. The method of claim 1, further comprising the step of generating a first import file comprising one or more of the data fields universal to each complex product and generating a second import file comprising one or more of the data fields universal to each complex product.

9. The method of claim 8, wherein one or more of the data fields universal to each complex product of the first import file are different than one or more of the data fields universal to each complex product in the second import file.

10. The method of claim 8, wherein data in one or more of the data fields universal to each complex product of the first import file is stored in a different format than the format of the data in one or more of the data fields universal to each complex product in the second import file.

11. The method of claim 1, further comprising the step of identifying the number of each configuration of a complex product in inventory.

12. The method of claim 11, further comprising the step of identifying an inventory limit for a configuration of a complex product and a price reduction amount to be applied to the price of the configuration of a complex product when the inventory limit is exceeded.

13. The method of claim 12, wherein the price of each product configuration of the complex product is based on the price of the complex product, the price of each selected option forming the product configuration for the complex product, and the price reduction amount when the inventory of a configuration of a complex product exceeds the inventory limit for that complex product.

14. The method of claim 13, wherein the product description data set comprises a master data record which includes a price and one or more attributes for each product configuration of the complex product.

15. The method of claim 13, wherein the product description data set comprises a configuration record for each configuration of a complex product which includes a price and one or more attributes for each product configuration of the complex product.

16. The method of claim 13, further comprising the step of generating an import file comprising one or more of the data fields universal to each complex product and each configuration of each complex product.

17. The method of claim 16, further comprising the step of generating a first import file comprising one or more of the data fields universal to each complex product and generating a second import file comprising one or more of the data fields universal to each complex product.

18. The method of claim 17, wherein one or more of the data fields universal to each complex product of the first import file are different than one or more of the data fields universal to each complex product in the second import file.

19. The method of claim 18, wherein data in one or more of the data fields universal to each complex product of the first import file is stored in a different format than the format of the data in one or more of the data fields universal to each complex product in the second import file.

20. The method of claim 3, further comprising the step of generating a manual worksheet comprising data on a configuration of a complex product when a change is made to data in a field of the configuration of a complex product.
